(19) United States
(12) Patent Application Publication
(10) Pub. No.: US 2025/0310000 A1
(43) Pub. Date: Oct. 2, 2025

(54) SYSTEMS AND METHODS FOR OPTIMAL RECEIVER DESIGN BASED ON LINEAR OPTICS FOR ENTANGLEMENT-ASSISTED SENSING AND COMMUNICATION

(71) Applicant: Arizona Board of Regents on Behalf of the University of Arizona, Tucson, AZ (US)

(72) Inventors: Quntao Zhuang, Tucson, AZ (US); Haowei Shi, Tucson, AZ (US); Bingzhi Zhang, Tucson, AZ (US)

(21) Appl. No.: 18/865,923

(22) PCT Filed: May 16, 2023
(86) PCT No.: PCT/US2023/022376

§ 371 Date: Nov. 14, 2024

Related U.S. Application Data
(60) Provisional application No. 63/342,402, filed on May 16, 2022.

(51) Int. Cl. H04B 10/70; G06N 10/20; H04B 10/548; H04B 10/63; H04B 10/64

(52) U.S. Cl. CPC H04B 10/70; G06N 10/20; H04B 10/548; H04B 10/63; H04B 10/64

(57) ABSTRACT

A receiver device with a correlation-to-displacement conversion unit converts quantum-entangled information into a coherent state for interpreting quantum-entangled and/or quantum-correlated signals. The correlation-to-displacement conversion unit can be configured for various practical applications, including phase sensing, entanglement-assisted communication, and quantum illumination-based target detection. Outputs of the correlation-to-displacement conversion unit include measurement results and conditional statistics for of return signals and corresponding idler signals of the quantum-entangled and/or quantum-correlated signals.

### CROSS REFERENCE TO RELATED APPLICATIONS

This is a PCT Patent Application that claims benefit to U.S. Provisional Patent Application Ser. No. 63/342,402 filed 16 May 2022, which is herein incorporated by reference in its entirety.

### GOVERNMENT SUPPORT

This invention was made with government support under grant number 2142882 awarded by the National Science Foundation. The government has certain rights in the invention.

### FIELD

The present disclosure generally relates to quantum-entangled signal processing, and in particular, to a system and associated method for a receiver device having a conversion unit for converting received quantum-entangled and/or quantum-correlated signal information into a coherent state while preserving information.

### BACKGROUND

Quantum entanglement not only refreshes understanding of the world but also brings unprecedented power to boost capabilities in sensing and communication. Entanglement is fragile; noise can easily destroy entanglement. Surprisingly, by evaluating information-theoretical limits of sensing and communication, people find that benefits from entanglement can even survive entanglement-breaking noise, for example in target detection, target ranging and classical communication. However, despite entanglement's surprisingly robust advantage, it is hard to actually design and build systems to fulfill such advantages, as information is delicately hidden in the bipartite or multipartite correlations. Indeed, till now the experimental demonstrations of these protocols are far from optimal and optimal receivers are either beyond near-term technology or completely unknown.

It is with these observations in mind, among others, that various aspects of the present disclosure were conceived and developed.

### SUMMARY

The following presents a simplified summary of various aspects described herein. This summary is not an extensive overview and is not intended to identify key or critical elements or to delineate the scope of the claims. The following summary merely presents some concepts in a simplified form as an introductory prelude to the more detailed description provided below. Corresponding apparatus, methods/processes, systems, and computer-readable media are also within the scope of the disclosure.

Aspects of the present inventive disclosure relate to receiving and decoding quantum-entangled and/or quantum-correlated signals. To accomplish this, the present disclosure provides a conversion unit for implementation on a receiver device that converts quantum-entangled and/or quantum-correlated signals into coherent-state values for semi-classical signal analysis, thereby simplifying the process of receiving and decoding a received quantum-entangled and/or quantum-correlated signal.

In particular, aspects of the present disclosure provide a system comprising: a receiver device operable for receiving a quantum-entangled and/or quantum-correlated signal, wherein the quantum-entangled and/or quantum-correlated signal includes a signal (e.g., a “return” signal carrying information) and a corresponding signal (e.g., an “idler” signal); and a processor in communication with a memory and the receiver device that implements aspects of the conversion unit, wherein the memory includes instructions, which, when executed, cause the processor to apply a heterodyne or homodyne measurement on the signal resulting in a measurement result for the signal and a conditional state of the corresponding signal, measure one or more modes of the corresponding signal based on the measurement result of the signal, and produce conditional statistics of the quantum-entangled and/or quantum-correlated signal based the measurement result. The conditional state of the corresponding signal includes displaced thermal state and/or squeezed and displaced thermal state. In some embodiments, the instructions further cause the processor to estimate a phase shift of the quantum-entangled and/or quantum-correlated signal, which can involve application of a homodyne detection algorithm to the corresponding signal to determine the phase shift of the quantum-entangled and/or quantum correlated signal. Further, in some embodiments, the instructions further cause the processor to determine properties of a target, which can involve application of a displacement and/or photodetection operation on the corresponding signal resulting in a measurement of the corresponding signal and can include iterative application of the displacement and/or photodetection operation on one or more components of the corresponding signal using at least one of: a classical control operation, a feed-forward operation and/or a feed-backward operation. In a further aspect, the instructions can cause the processor to decode the quantum-entangled and/or quantum-correlated signal based on the conditional state of the idler mode after detection on the signal mode, which can involve application of a quantum circuit including a beamsplitter array and photodetection on the idler mode. Further, the system can include a transmitter device, wherein the transmitter device is operable for communication with the receiver device and wherein the transmitter device is operable for transmitting the quantum-entangled signal, wherein the quantum-entangled signal includes a primary signal and a corresponding idler signal. The primary signal corresponds to the return signal, and the return signal includes noise in addition to the primary signal.

The present disclosure further provides validation of the conversion unit against various other quantum-entangled and/or quantum-correlated information extraction methods.

### BRIEF DESCRIPTION OF THE DRAWINGS

FIGS. 1A-1C show schematic diagrams of entanglement-assisted/classical (switches on/off) sensing or communication protocol and a correlation-to-displacement conversion unit for implementation on a receiver device for receiving and decoding quantum-entangled and/or quantum-correlated signals.

FIGS. 2A and 2B are graphical representations showing quantum illumination (QI) in the asymptotic region; FIG. 2A shows error probability versus identical copies M with signal brightness N_{S}=0.001, noise brightness N_{B}=20 and FIG. 2B shows error exponent ratio r_{C→D}/r_{CS} versus N_{S}, N_{B} where the dashed line represents the boundary of quantum advantage N_{S}≤N_{B} and the square in the top left corner of FIG. 2B indicates parameters chosen in FIG. 2A, where target reflectivity κ=0.01 in both cases.

FIGS. 3A and 3B are graphical representations showing quantum illumination (QI) in the non-asymptotic region where κ=0.01; FIG. 3A shows error probability ratio r_{C→D}/P_{H,CS} versus N_{S}, N_{B} with classical strategy's error probability P_{H,CS}=0.05 fixed, where the small square indicates the choice of N_{S}, N_{B} for FIG. 3B and the dashed line along the diagonal of FIG. 3A indicates the boundary of quantum advantage N_{S}≤N_{B}; FIG. 3B shows error probability versus the number of copies M with N_{S}=0.01, N_{B}=0.1 and the vertical line indicates the M values such that P_{H,CS}=0.05.

FIGS. 4A and 4B illustrate the ratio in quantum Fisher information over the coherent-state limit; FIG. 4A shows comparison between the conversion unit and EA upper bound as in Eq. (10) (dashed) under N_{B}=20, various N_{S}; FIG. 4B shows the conversion unit under various N_{S}, N_{B}, where channel transmissivity κ=0.01 and the dashed diagonal line indicates the boundary of quantum-enhanced region N_{S}=N_{B}/(1−κ).

FIGS. 5A and 5B are graphical representations showing information rates X_{C→D} normalized by the unassisted capacity C; FIG. 5A shows X_{C→D}/C under repetition coding order M=1 (darker solid) and M=10⁴ (lighter solid), compared with the ultimate EA capacity (dashed), where N_{B}=100, κ=0.01; FIG. 5B shows a contour of X_{C→D}/C versus N_{S}, N_{B}, where the dashed diagonal line indicates N_{S}=N_{B} and κ=0.01.

FIGS. 6A-6C are graphical representations showing various metrics; FIG. 6A shows QI error probability of receivers P_{E} with N_{S}=0.001, N_{B}=20 and κ=0.01, where the shaded area shows the precision of Monte-Carlo simulation for the Dolinar receiver (dot-dashed); FIG. 6B shows Fisher information per probe for phase estimation, normalized by the classical limit using coherent states (black solid), where the correlation-to-displacement-homodyne (CDH) receiver (double line in FIGS. 6A and 6B) is compared with the optical parameteric amplifier receiver (OPAR, light gray solid) and the phase-conjugate receiver (PCR, dense dashes). κ=0.98, N_{B}=1; FIG. 6C shows the information rate per mode of the Green machine (darker gray solid) using BPSK-encoded TMSV state, normalized by the unassisted capacity C, in comparison with the Holevo information χ_{C→D}/C (double line in FIG. 6C); for all FIGS. 6A-6C, performances of OPAR and PCR are respectively presented using dense dashed lines and light gray solid lines for reference.

FIG. 7 is a simplified diagram showing a schematic illustration of the correlation-to-displacement conversion unit of FIGS. 1B and 1C configured for quantum illumination target detection in the presence of noise.

FIGS. 8A and 8B are a pair of graphical representations respectively showing an optimal decision threshold of the photon counts N and error probability versus the number of copies M with N_{S}=0.001, N_{E}=20 and κ=0.01 for the correlation-to-displacement conversion unit of FIG. 7.

FIGS. 9A-9C are a series of graphical representations showing error performance for the correlation-to-displacement conversion unit of FIG. 7 with uniform phase and known reflectivity model and parameters N_{S}=0.001, N_{E}=20 and κ=0.01.

FIG. 10 is a graphical representation showing error performance for the correlation-to-displacement conversion unit of FIG. 7 when applied to the Rayleigh-fading model for QI target detection.

FIGS. 11A-11D are a series of process flow diagrams showing steps of a method applied by the correlation-to-displacement conversion unit of FIGS. 1B, 1C and 7, where FIG. 11A shows general steps of the method, FIG. 11B shows sub-steps of the method of FIG. 11A adapted for phase sensing, FIG. 11C shows sub-steps of the method of FIG. 11A adapted for entanglement-assisted communication, and where FIG. 11D shows sub-steps of the method of FIG. 11A adapted for QI target detection.

FIG. 12 is an exemplary computing system for implementation of the correlation-to-displacement conversion unit of FIGS. 1B, 1C and 7 and the methods of FIGS. 11A-11D.

Corresponding reference characters indicate corresponding elements among the view of the drawings. The headings used in the figures do not limit the scope of the claims.

### DETAILED DESCRIPTION

Quantum entanglement boosts performance limits in sensing and communication, and surprisingly even more in presence of entanglement-breaking noise. However, to fulfill such advantages requires a practical receiver design, a challenging task as information is encoded in the feeble quantum correlation after entanglement's death. The present disclosure provides a conversion unit to capture and transform such correlation to coherent quadrature displacement, and therefore enables the optimal receiver design for a wide range of entanglement-enhanced protocols, including target detection (quantum illumination), phase estimation, classical communication, target ranging and arbitrary channel pattern classification. The conversion unit maps the quantum detection problem to the semi-classical detection of noisy coherent states via a simple heterodyne and conditional passive linear optics. The conversion unit is completely off-the-shelf and provides a paradigm of processing noisy quantum correlations.

### 1. Conversion Unit

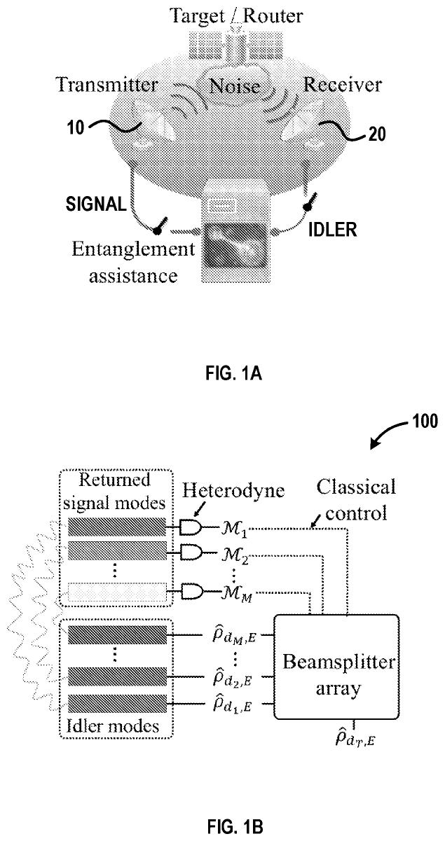

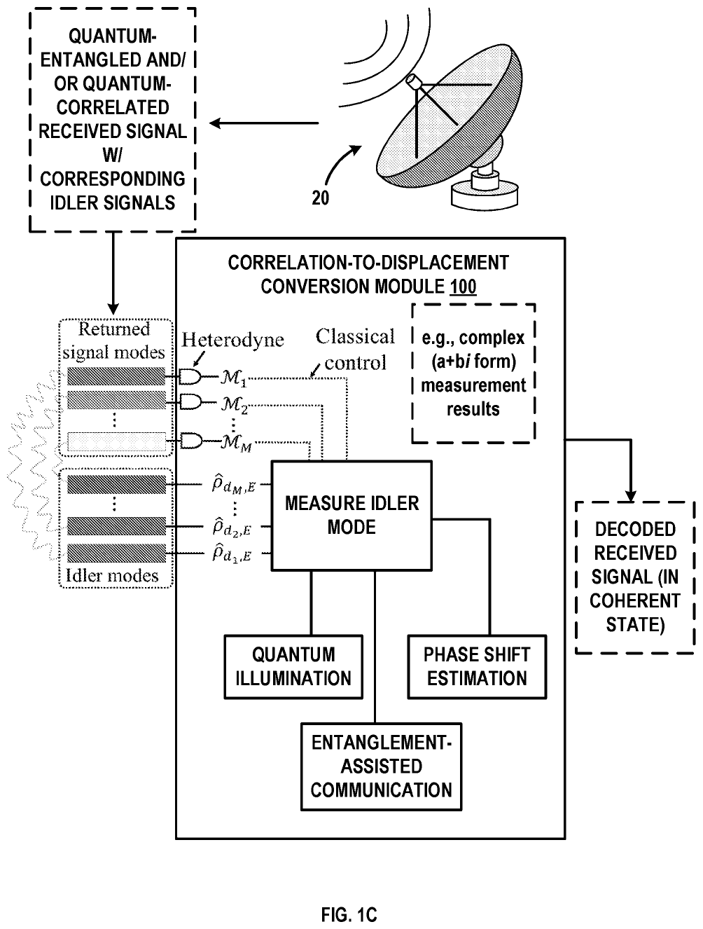

It is difficult to actually design and build systems to fulfill advantages of quantum entanglement, as information is delicately hidden in bipartite or multipartite correlations. As such, with reference to FIGS. 1A-1C, the present disclosure provides a conversion unit 100 from correlation to coherence that addresses this open problem and takes advantage of the benefits of quantum entanglement. The conversion unit 100 can be implemented on a receiver device 20 configured to receive a quantum-entangled and/or quantum-correlated signal from a transmitter device 10. The quantum-entangled signal transmitted from the transmitter device 10 can include a primary signal associated with a corresponding idler signal. In particular, the idler signal is stored at the receiver device 20 to be detected together. When the primary signal passes through a medium (such as air or fiber) and/or bounces off of a physical target or routing node before reaching the receiver device 20, the primary signal becomes a return signal with additional noise. As such, the quantum-entangled and/or quantum-correlated signal received at the receiver device includes the return signal with noise and the corresponding idler signal. However, due to the initial quantum-entanglement, the receiver device 20 needs to be able to convert quantum-entangled and/or quantum-correlated information including phase-sensitive cross-correlation between signals and their corresponding idlers into a semi-classical problem, which can be in the form of an in-general complex amplitude of a coherent quantum state, therefore mapping the quantum problem to a semi-classical one and taking advantage of quantum entanglement for improved information extraction. To clarify, the conversion unit 100 converts the original quantum-entangled and/or quantum-correlated signal to a coherent signal that is similar to quantum states involved in laser communication, with little additional noise and while retaining information preservation from the original quantum-entangled and/or quantum-correlated signal. The conversion unit 100 applies heterodyne or homodyne detection on the return signal to reveal information encoded in the delicate remaining cross-correlation after entanglement's death, particularly through coherent quadrature displacement of ancilla.

The present disclosure proves that such a correlation-to-displacement conversion preserves almost all information and therefore enables optimal entanglement-assisted (EA) target detection (quantum illumination, QI), phase sensing, classical communication, target ranging and arbitrary channel pattern classification. Moreover, the conversion unit enables exact performance analyses and extends quantum advantages to the non-asymptotic region, unexplored due to the limitations of asymptotic tools. It also allows the proof of a folklore of a 6 decibel error exponent advantage in an arbitrary channel pattern classification problem. In some embodiments, the receiver device 20 can be combined with a coherent-state receiver device and can implement the conversion unit 100 using off-the-shelf components of linear optics and photon detection. The correlation-to-displacement conversion unit has broad application and brings new insights into how quantum correlations can be processed.

### 1.1 Entanglement-Assisted Protocol

A sensing protocol in general aims to obtain information about a physical process. As shown in FIG. 1A, a probe signal is sent out from the transmitter device 10 to interact with the physical process (such as reflection induced by a target), and then unavoidably encounters noise, before finally being detected by the receiver device 20. Similarly, in a communication protocol, a signal carrying a classical message goes from the transmitter device 10 through a noisy link to get detected by the receiver device 20. In both cases, the final detection requires a structured receiver to extract information. An EA protocol entangles an initial signal with an ancilla, which is jointly measured at the receiver device 20 with the received signal to boost the information extraction performance.

In the above paradigm, light propagation (including the physical process and noise) can be modeled as an overall phase-shift thermal-loss channel Φ_{κ,θ}, with κ being a transmissivity and θ being a phase shift parameter. For a given input mode described by annihilation operators â_{S}, a corresponding output mode can be represented by:

$${\hat{a}}_{R} = {e}^{i θ} \sqrt{κ} {\hat{a}}_{S} + \sqrt{1 - κ} {\hat{a}}_{B} , \qquad Eq . ( 1 )$$

where â_{B} models a thermal background (e.g., noise).

As shown in FIG. 1A, in a sensing protocol, â_{S} describes a probe signal sent out from the transmitter device 10 that interacts with a subject, encounters noise modeled by â_{B} and is detected at the receiver device 20. Such a channel can model various different sensing and communication scenarios.

For example, in an ideal target detection scenario, a present target reflects a κ portion of the signals back to the receiver device 20 corresponding to the channel Φ_{κ,0}, assuming a known reflection phase. When the target is absent, only noise can be received, and the channel is Φ_{0,0}.

In a phase-sensing scenario that models applications such as bio-sensing, ranging and gravitational-wave detection, the phase shift parameter θ of channel Φκ,θ can be estimated.

In a phase-shift-keying (PSK) communication protocol, one encodes a classical message θ to the phase of the signal e^{iθ}â_{S}, and then a κ portion of the signal is received mixed with noise. As such, light propagation is modeled as an overall channel Φ_{κ,θ} from encoding at the transmitter to receipt at the receiver.

To boost the information extraction performance, an entanglement-assisted strategy entangles the initial signal with an ancilla, which is jointly measures with the received signal. Despite the entanglement-breaking noise, surprisingly, by evaluating information-theoretical limits, people find that benefits from entanglement survive in the above-mentioned target detection (quantum illumination, QI) and classical communication scenarios.

To benefit from entanglement, consider M signal-idler pairs sent by a transmitter device 10 {â_{S}_{ₘ}, â_{I}_{ₘ}}ₘ₌₁^{M}, where each pair is in a two-mode squeezed-vacuum (TMSV) state with mean photon number N_{S}, known to be optimal in these applications. While the signals are sent through the channel Φ_{κ,θ}, the idlers are stored or pre-shared to the receiver device 20, leading to M return-idler pairs {â_{R}_{ₘ}, â_{I}_{ₘ}}. Each return-idler pair maintains a phase-sensitive cross-correlation [symbol] â_{R}_{ₘ}, â_{I}_{ₘ} [symbol] =e^{iθ}Cₚ with amplitude Cₚ=\sqrt{κN_{S}(N_{S}+1)}. Entanglement's advantage comes from the fact that when N_{S} is small, the amplitude of the correlation ∂\sqrt{N_{S}} in an EA protocol. As a comparison, for a classical sensing protocol with a coherent-state probe of the same brightness N_{S} and strong local oscillator as the reference, the correlation ∂N_{S} and is therefore much smaller when N_{S} is small. In this regard, the crucial part of a receiver device 20 to enable entanglement advantage is to detect phase-sensitive cross correlation.

### 1.2 Correlation-to-Displacement Conversion

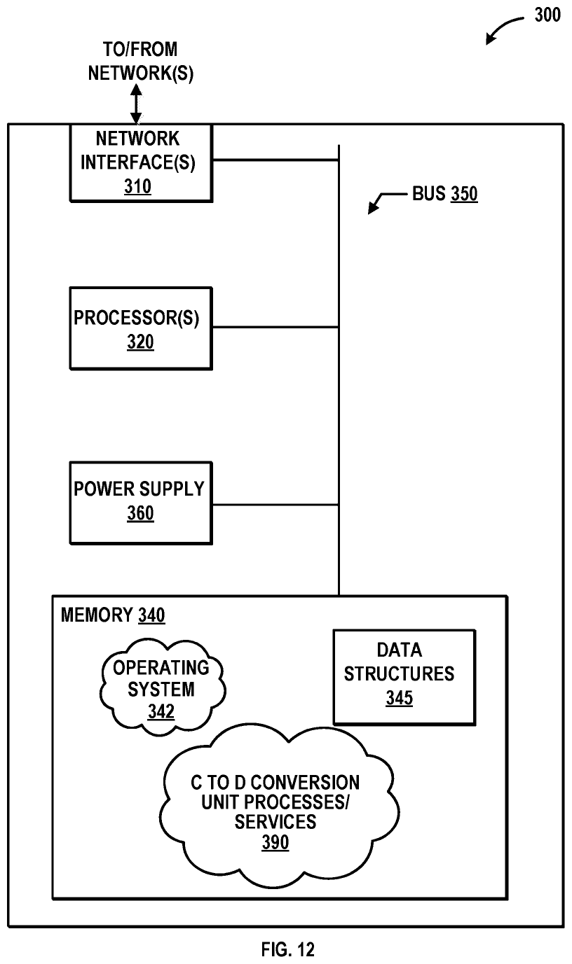

The present disclosure includes a conversion unit 100 for implementation on a receiver device 20 that converts phase-sensitive cross-correlation between M signal-idler pairs (e.g., including signals and their corresponding idlers) received at the receiver device 20 to the complex displacement amplitude of a single coherent state. Through the conversion unit 100, the quantum problem of receiver design can be mapped to a semi-classical problem of coherent state processing, thereby taking advantage of quantum entanglement. The conversion unit 100 can be part of a system including a processor in communication with a memory (e.g., processor 320 and memory 340 of FIG. 12), where the processor is in communication with the receiver device 20. In some examples, the conversion unit 100 can include the receiver device 20 integrated within.

The receiver device 20 can receive a quantum-entangled and/or quantum-correlated signal sent by the transmitter device 10. The quantum-entangled and/or quantum-correlated signal sent by the transmitter device 10 includes a primary signal and an idler signal that corresponds with the primary signal.

The receiver device 20 in communication with the processor of the conversion unit 100 can receive the quantum-entangled and/or quantum-correlated signal, in the form of a signal and a corresponding signal. Importantly, the signal received at the receiver device can be referred to as a return signal (or a “return”) that corresponds with the primary signal sent by the transmitter device 10 and can include noise. The corresponding signal received at the receiver device can also be referred to herein as an idler signal. Importantly, the corresponding signal corresponds directly with the return signal received at the receiver device 20 and the idler signal sent by the transmitter device 10. Aspects of the corresponding (idler) signal are stored at the receiver device 20 upon receipt to enable decoding of the message present in the return signal.

At the processor of the conversion unit 100, upon receipt of the quantum-entangled and/or quantum-correlated signal at the receiver device 20, the conversion unit 100 can apply a heterodyne measurement or homodyne measurement on the signal (e.g., the return signal) resulting in a measurement result of the signal. This also results in the corresponding signal being transformed into a conditional state (which can include a displaced thermal state, or a displaced and squeezed thermal state). Following acquisition of the measurement result of the signal, the conversion unit 100 can measure one or more modes of the corresponding signal based on the measurement result of the signal. The conversion unit 100 can then produce one or more resulting conditional statistics from the quantum-entangled and/or quantum-correlated signal based on the measurement result. Based on the measurement result of the signal and the one or more resulting conditional statistics of the quantum-entangled and/or quantum-correlated signal, the conversion unit 100 can decode the quantum-entangled and/or quantum-correlated signal.

In some examples, the measurement results and conditional statistics obtained by the conversion unit 100 can be dependent upon a specific practical application that the conversion unit 100 is being used for.

In some embodiments, the conversion unit 100 can estimate a phase shift of the quantum-entangled and/or quantum-correlated signal. In this scenario, the conversion unit 100 can apply, conditioned on the measurement result of the signal, a heterodyne measurement or a homodyne measurement to the corresponding signal resulting in a measurement result of the corresponding signal. Based on the measurement result of the signal and based on the measurement result of the corresponding signal, the conversion unit 100 can determine the phase shift of the quantum-entangled and/or quantum-correlated signal.

Further, steps taken by the conversion unit 100 for measuring of the one or more modes of the corresponding signal can be dependent upon a frequency range of the quantum-entangled and/or quantum-correlated signal.

In some examples where the quantum-entangled and/or quantum-correlated signal is from a quantum target detection protocol, such as for target detection and characterization tasks, the conversion unit 100 can apply, conditioned on the measurement result of the signal, a displacement operation and/or a photodetection operation on the corresponding signal resulting in a measurement result of the corresponding signal. In some examples, this can include iteratively applying the displacement operation and/or the photodetection operation on one or more components of the corresponding signal using at least one of: a classical control operation, a feed-forward operation and/or a feed-backward operation. Using this information, the conversion unit 100 can detect, based on the measurement of the corresponding signal, one or more properties of a target or multiple targets, including presence and/or absence, range, velocity and/or angle.

In another example, where the quantum-entangled and/or quantum-correlated signal is from a communication protocol, the conversion unit 100 can apply, conditioned on the measurement result of the signal, one or more quantum circuits and a photodetection operation to the corresponding signal resulting in a measurement result of the corresponding signal. The one or more quantum circuits can include a beamsplitter array. Using this information, the conversion unit 100 can extract an encoded classical message from the quantum-entangled and/or quantum-correlated signal based on the one or more resulting conditional statistics.

While the present disclosure discusses the quantum-entangled and/or quantum-correlated signal received at the receiver device 20 in terms of a signal (e.g., a return signal) and a corresponding signal (e.g., an idler signal corresponding with the return signal), the techniques outlined herein can be applied to a quantum-entangled and/or quantum-correlated signal received at the receiver device 20 that includes a plurality of signals (e.g., a plurality of return signals) and a plurality of corresponding signals (e.g., a plurality of idler signals that correspond with the return signals), each corresponding signal corresponding with a respective signal of the plurality of signals.

Given a set of return-idler pairs (e.g., a set of return signals paired with a set of corresponding signals) received at a receiver device 20, {â_{R}_{ₘ}, â_{I}_{ₘ}}ₘ₌₁^{M}, as shown in FIGS. 1B and 1C, the conversion unit 100 first performs individual heterodyne measurement or homodyne measurement on each respective return â_{R}_{ₘ}, producing a complex measurement result [symbol] ₘ (e.g., the measurement result discussed above). The complex measurement result s can generally obey a circularly-symmetric complex Gaussian distribution with variance [symbol] =(N_{B}+κN_{S}+1)/2. Conditioned on the complex measurement result [symbol] ₘ, idler modes (e.g., of the corresponding (idler) signals) each a_{I}_{ₘ} can be considered in a displacement thermal state \hat{ρ}_{d}_{ₘ}_{,E}, with mean dₘ=(Cₚ/ [symbol] )e^{iθ} [symbol] and thermal noise photon number: E=N_{S}(N_{b}+1−κ)( [symbol] )≤N_{S}.

At this stage, conditioned on the measurement result of the signal, the receiver device 20 with the conversion unit 100 can implement various strategies for measuring idler modes (e.g., of the corresponding signals that correspond with the return signals) to enable information extraction. The measured idler modes can be used for applications such as entanglement-assisted communication (e.g., decoding classical messages that were encoded and transmitted using properties of quantum entanglement), quantum illumination (e.g., target detection), and phase shift estimation (e.g., for applications such as bio-sensing, ranging and gravitational-wave detection).

In one example for entanglement-assisted communication, as shown in FIG. 1B, the conversion unit 100 can apply a passive linear optical transform to the corresponding signal through one or more quantum circuits and a photodetection operation (e.g., through a beamsplitter array with weights {wₘ=dₘ*/|d_{T}|}) which can combine all M idler modes into a single mode Σₘ₌₁^{M}wₘâ_{I}_{ₘ} in state \hat{ρ}_{d}_{_{T}}_{,E}, with mean d_{T}=|d_{T}|e^{iθ} and thermal noise E. Here, the amplitude square |d_{T}|²=Σₘ₌₁^{M}=₁|dₘ|² satisfies the χ² distribution of 2M degrees of freedom:

$${P}_{κ}^{( M )} ( x ) ∝ {( \frac{x}{ξ} )}^{M - 1} {e}^{- x / ( 2 ξ )} ,$$

with mean 2Mξ and variance 4Mξ², where ξ=Cₚ²/4v_{M}. Using this information, the conversion unit 100 can extract an encoded classical message from the quantum-entangled and/or quantum-correlated signal based on one or more conditional statistics that can be deduced using the measurement result of the (return) signal and the measurement result of the corresponding (idler) signal.

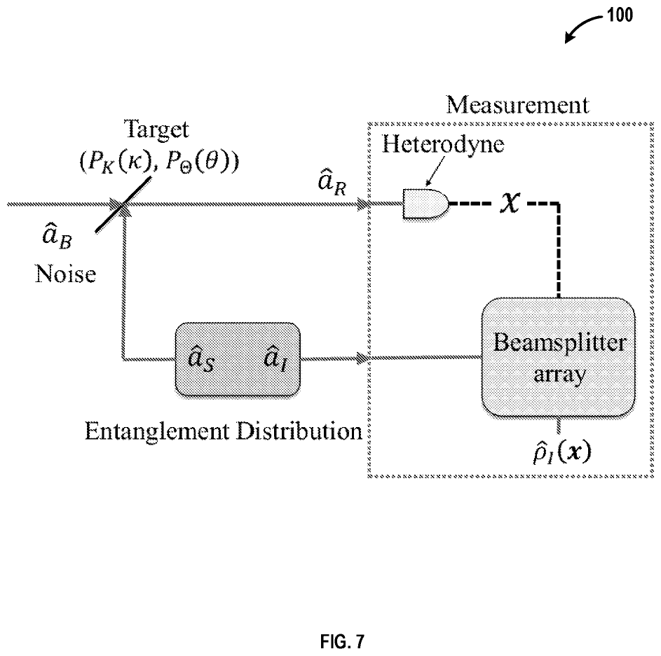

The conversion unit 100 can also be applied to a quantum illumination scenario where the quantum-entangled and/or quantum-correlated signal received at the receiver device 20 is from a quantum target detection protocol. Conditioned on the measurement result of the (return) signal, the conversion unit 100 can apply a displacement operation and/or a photodetection operation on the corresponding signal resulting in a measurement result of the corresponding (idler) signal. This step can be iteratively applied on one or more components of the corresponding signal using at least one of: a classical control operation, a feed-forward operation and/or a feed-backward operation. Using the measurement of the corresponding (idler) signal, the conversion unit 100 can detect one or more properties of a target or multiple targets, including presence and/or absence of the target or multiple targets, range of the target or multiple targets, velocity of the target or multiple targets and/or angle of the target or multiple targets. Section 4 (and FIG. 7) discussed herein provides details on quantum illumination and how the conversion unit 100 handles noise.

In a further example, the conversion unit 100 can also be applied to a phase-sensing scenario where the goal is to determine a phase-shift of the quantum-entangled and/or quantum-correlated signal received at the receiver device 20. Phase-sensing can be useful for applications involving bioinformatics and gravitational-wave detection. Conditioned on the measurement result of the (return) signal, the conversion unit 100 can apply a heterodyne measurement or a homodyne measurement to the corresponding (idler) signal resulting in a measurement result of the corresponding (idler) signal. Based on the measurement result of the (return) signal and based on the measurement result of the corresponding (idler) signal, the conversion unit 100 can determine the phase shift of the quantum-entangled and/or quantum-correlated signal.

A few points are worth addressing before providing the performance analyses. First, the experimental realization of the beamsplitter array (e.g., of the one or more quantum circuits) depends on the specific protocol. For time-domain modes, it can be realized by a single beamsplitter that adjusts its ratio to combine a stored mode with each incoming mode. For frequency modes, it can be potentially realized by an integrated four-wave mixing process. Second, although heterodyne detection on TMSV has been conceptually utilized in the security proof of quantum key distribution, the adaptive manipulation of the conditional quantum state, for the sensing and communication purpose, in such a noisy environment has never been considered.

### 2. Performance Limits

Here, the present disclosure analyzes various performance limits of the correlation-to-displacement (C′→D′) operations performed by the conversion unit 100.

### 2.1 Quantum Illumination

For Quantum illumination (QI), useful for target detection, the conversion unit 100 considers a discrimination between the two channels Φ_{0,0} (corresponding to “target absent”) and Φ_{κ,0} (corresponding to “target present”). In this case, the conversion unit 100 produces conditional statistics including two displaced thermal states as outputs: \hat{ρ}_{0,N}_{_{S}} (target absent) and \hat{ρ}_{\sqrt{x},E} (target present), where x˜P_{κ}^{(M)}(·) obeys the χ² distribution. This leads to an error probability performance limit:

$${P}_{C \to D} = \int d x {P}_{κ}^{( M )} ( x ) {P}_{H} ( {\hat{ρ}}_{0 , {N}_{S}} , {\hat{ρ}}_{\sqrt{x} , E} ) \qquad Eq . ( 2 )$$

where P_{H}(\hat{ρ}, \hat{σ}) is the Helstrom limit of error probability in discriminating between states \hat{ρ} and \hat{σ} with equal prior probability.

To compare with the ultimate performance, the present disclosure provides an evaluation of the Nair-Gu (NG) lower bound on the error probability applicable to any source of illumination P_{NG}. To benchmark for entanglement advantage, the present disclosure also considers the Helstrom limit of an optimal classical scheme based on coherent states

$${P}_{H , CS} = {P}_{H} ( {\hat{ρ}}_{0 , {N}_{B}} , {\hat{ρ}}_{\sqrt{{MN}_{S}} , {N}_{B}} ) .$$

The evaluation begins with the asymptotic limit of low brightness N_{S}<<1 and low reflectivity κ<<1, where M is large to guarantee a decent signal-to-noise ratio. At this limit, \hat{ρ}_{\sqrt{x},E} can be approximated as a coherent state and \hat{ρ}_{0,N}_{_{S}} as vacuum. Therefore, the Helstrom limit

$${P}_{H} ( {\hat{ρ}}_{0 , {N}_{S}} , {\hat{ρ}}_{\sqrt{x} , E} ) ≃ {e}^{- x} / 4$$

and Eq. (2) leads to:

$${P}_{C \to D} ≃ \frac{1}{4} {( 1 + 2 ξ )}^{- M} ≃ \frac{1}{4} exp \{ - M {r}_{C \to D} \} \qquad Eq . ( 3 )$$

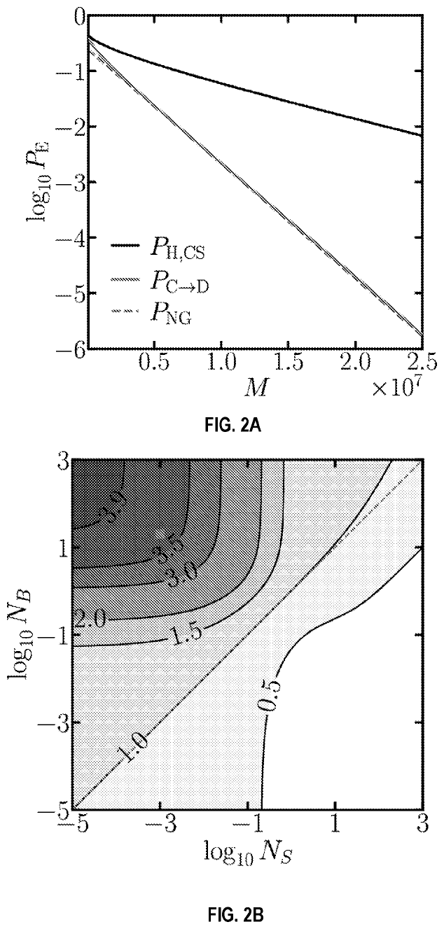

which saturates the lower bound P_{NG} with the error exponent r_{C→D}=2ξ. In fact, one can easily check that the optimality holds as long as N_{S}<<1 and κ<<1+N_{B}. This optimality is verified in FIG. 2A, where a close agreement is seen between P_{C→D} and PNG. At the same time, significant advantages over the classical limit P_{H,CS} can be observed.

Now, the present disclosure examines the error exponent more closely. In general, when ξ<<1 (e.g., due to κ<<1) a lower bound on the error exponent can be obtained, r_{C→D}≥2ξ(\sqrt{N_{S}+1}−\sqrt{N_{S}})², while the coherent state error exponent r_{CS}=κN_{S}(\sqrt{N_{B}+1}−\sqrt{N_{B}})². The entanglement advantage exists as long as the signal brightness is smaller than the noise brightness, i.e., N_{S}≤N_{B}, as also confirmed in FIG. 2B via r_{C→D}/r_{CS}.

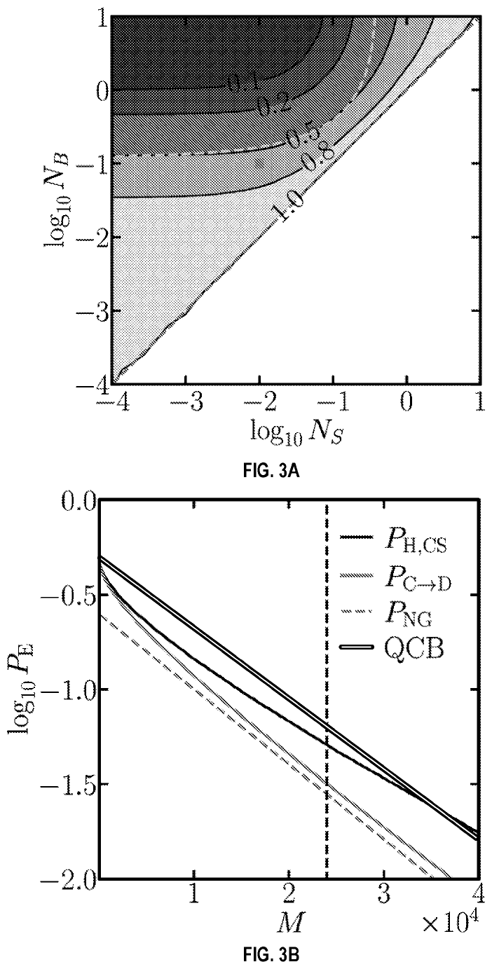

Finally, Eq. (2) provides an efficiently calculable and achievable error-probability lower bound for QI, in contrast to the asymptotically tight quantum Chernoff (upper) bound (QCB). As a consequence, Eq. (2) allows the exploration of QI's advantage in the non-asymptotic region. As shown in FIG. 3A, when the classical Helstrom limit is fixed at P_{H,CS}=0.05, the ratio P_{C→D}/P_{H,CS}≤1 when N_{S}≤N_{B} (above the dashed line along the diagonal). However, QCB can only show quantum advantage in a strictly smaller region above the lighter dashed curve near the “0.5” curve. A set of parameters N_{S}, N_{B} are selected to explicitly plot the error probability versus number of copies M in FIG. 3B—when M is small, QCB fails to identify quantum advantage, while Eq. (2) shows advantage.

### 2.2 Quantum Phase Estimation

For quantum phase estimation, the conversion unit 100 estimates the phase shift θ of the channel Φ_{κ,θ} for light propagation described with reference to Eq. (1). The conversion unit 100 determines conditional statistics including a displaced thermal state

$${\hat{ρ}}_{{e}^{i θ} \sqrt{x} , E} ,$$

where x˜P_{κ}^{(M)}(·). The variance of unbiased estimators has an asymptotically tight lower bound δθ²=1/ [symbol] , with [symbol] being the quantum Fisher Information (QFI). The overall QFI enabled by the conversion unit 100 can be obtained as:

$${ℱ}_{C \to D} = \frac{4 M κ {N}_{S} ( {N}_{S} + 1 )}{1 + {N}_{B} + {N}_{S} ( 2 {N}_{B} + 2 - κ )} \qquad Eq . ( 4 )$$

The present disclosure compares [symbol] _{C→D} with the ultimate upper bound of Fisher information [symbol] _{UB}. At low brightness N_{S}<<1, then [symbol] _{C→D}≈[1−κ/(1+N_{B})] [symbol] _{UB}; and if reflectivity κ is low, then [symbol] _{C→D}≈ [symbol] _{UB} achieves the optimum.

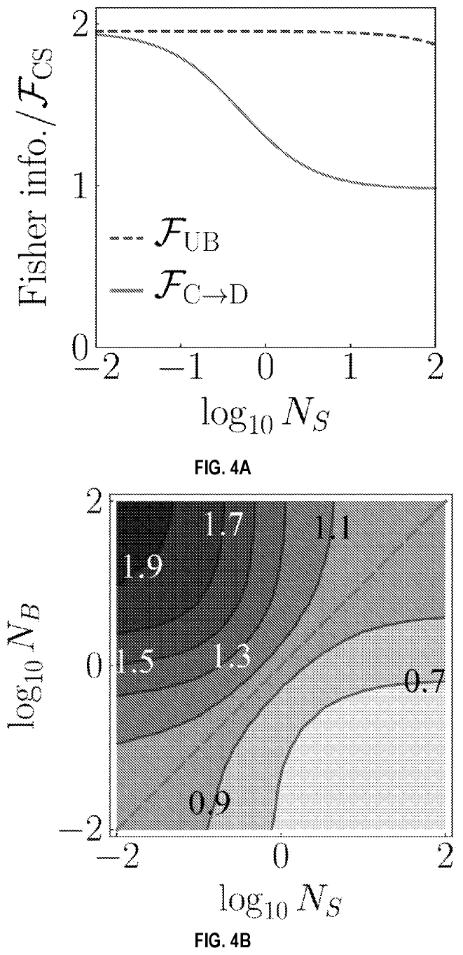

Now the present disclosure shows the quantum advantage by comparing with the classical limit using coherent-state sources [symbol] _{CS}=4MκN_{S}/(1+2N_{B}). When the noise N_{B}>>1, the optimal performance of [symbol] _{C→D} has a factor of two advantage over the classical performance [symbol] _{CS}, as verified in FIG. 4A. Comparing [symbol] _{C→D} and [symbol] _{CS}, quantum advantage can be shown ( [symbol] _{C→D}≥ [symbol] _{CS}) as long as N_{S}≤N_{B}/(1−κ), which is indeed verified in FIG. 4B.

### 2.3 Entanglement Assisted Communication

Consider PSK with repetitions, where the M signal modes are modulated by the same phase θ uniformly randomly chosen from [0, 2π). The output of the conversion unit 100 would include conditional statistics, including a displaced thermal state

$${\hat{ρ}}_{\sqrt{x} {e}^{i θ} , E} ,$$

where x˜P_{κ}^{(M)}(·). At this point, the achievable information rate per mode from the output state is:

$${χ}_{C \to D} = \frac{1}{M} \int {dxP}_{κ}^{( M )} ( x ) χ ( \{ {\hat{ρ}}_{\sqrt{x} {e}^{i θ} , E} \} ) \qquad Eq . ( 5 )$$

where

$$χ ( \{ {\hat{ρ}}_{\sqrt{x} {e}^{i θ} , E} \} )$$

is the Holevo information of the corresponding state ensemble.

Due to the uniform phase modulation and the Gaussian nature of each state

$${\hat{ρ}}_{\sqrt{x} {e}^{i θ} , E} ,$$

Eq. (5) can be efficiently evaluated.

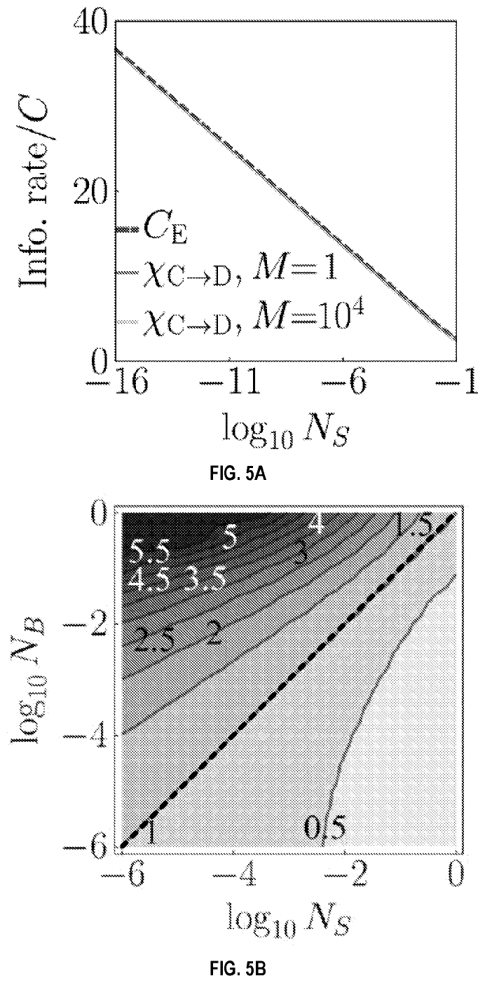

To compare with ultimate performance, consider the EA classical capacity C_{E}. At the same time, to understand the advantage over the classical schemes, the present disclosure provides a comparison with the classical capacity without assistance C. With reference to FIG. 5A, note that χ_{C→D} approaches C_{E}, therefore verifying the optimality of the conversion unit 100 and fulfilling the EA advantage in communication. Indeed, at the limit N_{S}→0, X_{C→D}˜κN_{S}ln(1/N_{S})/(N_{b}+1) is obtained, which achieves the scaling of the ultimate EA capacity. The same optimality result also holds for the binary PSK modulation.

To fully understand the advantage enabled by the conversion unit 100, FIG. 5B plots the ratio χ_{C→D}/C versus N_{S}, N_{B}. When N_{S}<<1, N_{B}>>1, the advantage is visible; it is shown that when N_{S}≤N_{B}, quantum advantage can be identified, similar to the previous cases. Note that the N_{S}<<1 region is relevant to covert communication, where the brightness is low to avoid the revelation of communication attempts.

### 2.4 Channel Pattern Classification

So far, the present disclosure considered the sensing of a single phase-shift thermal-loss channel Φ_{κ,θ}. In general, complex sensing problems often involve composite channels with M different sub-channels, Φ_{κ,θ}=⊖ₘ₌₁^{M}Φ_{κ}_{ₘ}_{,θ}_{ₘ}, where the vector notation κ={kₘ}ₘ₋₁^{M}, 0={θₘ}ₘ₌₁^{M}, assuming that the noise background N_{B} is generally identical across all sub-channels. Previous works on quantum channel position-finding, barcode recognition, quantum ranging, and absorption spectrum recognition can all be considered as special cases of this composite channel.

Theorem 1. In the high noise N>>1 and low signal brightness N_{S}<<1 limit, entanglement from two-mode squeezed vacuum enables a factor of four (6 dB) advantage over classical sources of coherent states for general multiple composite channel discrimination.

The proof directly utilizes the C→D conversion unit 100, and is achievable with the conversion unit 100 plus optimal discrimination between multiple coherent states. This result immediately implies that the conversion unit 100 is also optimal in the discrete version of target ranging problem.

### 2.5 Receiver Implementation

With the conversion unit 100, the detection of cross-correlation in EA scenarios is reduced to the detection of single-mode semi-classical coherent states, where receiver designs and measurement designs have been extensively explored theoretically and experimentally.

Below, the present disclosure provides example implementations for the receiver device 20 using the conversion unit 100 based on linear optics and photon detection for measurement. The conversion unit 100 is also benchmarked with practical receiver schemes based on optical parametric amplifier receivers (OPAR) or phase conjugation receivers (PCR).

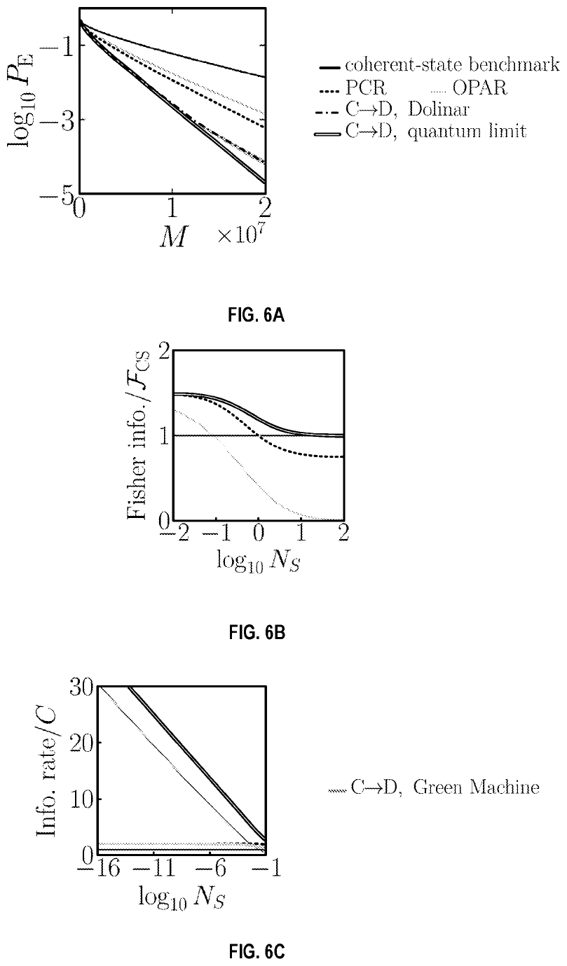

For QI target detection, the conversion unit 100 outputs coherent states with low noise at the N_{S}<<1; therefore a Dolinar receiver (Algorithm 1) can saturate the Helstrom limit and complete the optimum receiver design for measurement. FIG. 6A evaluates the performance of the Dolinar receiver combined with a C→D conversion unit 100 (dot-dashed), which indeed achieves the optimal error probability (double line). Some discrepancy can be found when M is too large, due to the small noise E≈N_{S} being significant at low error probability. As expected, OPAR (dense dashes) and PCR (light gray solid line) receiver designs give worse performance, although still better than the coherent-state homodyne scheme (black).

Algorithm 1 Dolinar Receiver

```
S, h, γ = \sqrt{|α|²}/\sqrt{2S}
k ← 1, g ← None
while k ≤ S do
  $if {p}_{0}^{( k )} > {p}_{1}^{( k )} then$
  $if {p}_{0}^{( k )} > {p}_{1}^{( k )} then$
    g ← 0
  $else if {p}_{0}^{( k )} < {p}_{1}^{( k )} then$
    g ← 1
  else
    g ← {0, 1} with equal probability
  end if
  if g = 0 then
    perform displacement-γ + u^{(k)}
  else
    perform displacement-γ − u^{(k)}
  end if
  Measure the photon number N^{(k)} with probability pn(N^{(k)}, g|h)
  Update prior probability
    ${p}_{0}^{( k + 1 )} ← {p}_{0}^{( k )} p ( {N}^{( k )} , g \vert 0 ) / {\sum }_{h ′ = 0}^{1} {p}_{h ′}^{( k )} p ( {N}^{( k )} , g \vert {h}^{′} )$
    ${p}_{1}^{( k + 1 )} ← {p}_{1}^{( k )} p ( {N}^{( k )} , g \vert 1 ) / {\sum }_{h ′ = 0}^{1} {p}_{h ′}^{( k )} p ( {N}^{( k )} , g \vert {h}^{′} )$
end while
$if {p}_{0}^{S + 1} > {p}_{1}^{S + 1} then$
  g ← 1
else
  g ← {0, 1} with equal probability
end if
return g
```

For phase estimation, a simple homodyne detection on the C→D conversion unit 100 output achieves the Fisher information in Eq. (4) and completes the receiver design for measurement. Although OPAR and PCR designs are also asymptotically optimal, the C→D scheme applied by the conversion unit 100 results in larger Fisher information in the non-asymptotic region, especially when κ is close to unity, as can be verified in FIG. 6B.

For EA communication, after the conversion unit 100, the rest of the receiver design problem reduces to achieving the Holevo information among an ensemble of noisy coherent state. To enable a near-term receiver, consider binary PSK combined with a Hadamard code and a Green machine. The performance of the optimized Hadamard code is shown in FIG. 6C (darker gray solid), which achieves the optimal ln(1/N_{S}) scaling of χ_{C→D} while relying on linear optics and photon counting. Note that the constant factor “off” here is not due to the conversion unit 100, which achieves optimal results as shown in FIG. 5A; rather, the Green machine has room for improvement.

### 2.6 Summary

The conversion unit 100 resolves the optimal receiver design problem for a wide range of entanglement-assisted sensing and communication problems. The conversion unit 100 can be implemented on a receiver device 20 and provides a unique approach for solving quantum detection problem by reducing the quantum detection problem to a semi-classical detection problem. In terms of microwave QI, a recent experiment has eventually realized a 20% advantage in the error exponent using sub-optimal OPAR design. The conversion unit 100 is practical in that it does not require the return signals and the stored idlers to interact. One heterodyne detects the returned signals and performs (potentially adaptive) photon counting on all idler modes conditioned on measurement results, leading to tremendous simplification in experimental realizations. Section 3 herein outlines some analyses on the outputs that can be obtained using the conversion unit 100. Although a Gaussian channel model with no phase noise is modeled within these examples, the conversion unit 100 can also operate in the presence of non-Gaussian phase noise to take advantage of entanglement as discussed in section 4 herein.

### 3. Detailed Analyses for Correlation-to-Displacement Conversion

### 3.1 Measurement Statistics

In the above sections, the present disclosure considers a pair of modes (denoted as ‘signal’ and ‘idler’ modes, respectively associated with the (return) signal and the corresponding (idler) signal received at the receiver device 20) in a two-mode squeezed vacuum (TSMV) state with mean photon number N_{S}. These can be described by the covariance matrix in Eq. (6), and resulting channel output with covariance matrix in Eq. (7). For the conversion unit 100, quantum entanglement can be considered from a TMSV state, which is a zero-mean two-mode Gaussian state with the covariance matrix:

$${V}_{SI} = ( \begin{matrix}( 2 {N}_{S} + 1 ) & 2 \sqrt{{N}_{S} ( {N}_{S} + 1 )} \\ 2 \sqrt{{N}_{S} ( {N}_{S} + 1 )} & ( 2 {N}_{S} + 1 )\end{matrix} ) \qquad Eq . ( 6 )$$

where [symbol] is the Pauli-Z matrix and [symbol] is a 2×2 identity matrix.

The TMSV state is still Gaussian after the signal mode is transmitted through a bosonic Gaussian channel. For the input-output relation in Eq. (1), the covariance matrix of the return and the idler is:

$${V}_{RI} = ( \begin{matrix}( 2 κ {N}_{S} + 2 {N}_{B} + 1 ) & 2 \sqrt{κ {N}_{S} ( {N}_{S} + 1 )} R \\ 2 \sqrt{κ {N}_{S} ( {N}_{S} + 1 )} {R}^{T} & ( 2 {N}_{S} + 1 )\end{matrix} ) , \qquad Eq . ( 7 )$$

$$where R = ( \begin{matrix}cos θ & - sin θ \\ sin θ & cos θ\end{matrix} ) .$$

By performing the heterodyne measurement on the returned mode, the returned mode is mapped to a coherent state with mean x̅_̅{̅Π̅}̅≡(q_{Π}, p_{Π}) and identity covariance matrix, V_{Π}= [symbol] . In general, for input states \hat{ρ}_{RI} of a single pair for the return signal and the corresponding (idler) signal, conditioned on the heterodyne measurement result (q_{Π},p_{Π}), the conversion unit 100 produces an output state:

$${\hat{ρ}}_{I} = \frac{〈 {q}_{⊓} + {ip}_{⊓} \vert {\hat{ρ}}_{RI} \vert {q}_{⊓} + {ip}_{⊓} 〉}{tr [ 〈 {q}_{⊓} + {ip}_{⊓} \vert {\hat{ρ}}_{RI} \vert {q}_{⊓} + {ip}_{⊓} 〉 ]} \qquad Eq . ( 8 )$$

where |q_{Π}+ip_{Π} [symbol] is a coherent state with amplitude q_{Π}+ip_{Π}. The input-output relation can be expressed in characteristic function. Starting from the general two-mode input characteristic function:

$${\hat{ρ}}_{RI} = \frac{1}{{( 2 π )}^{2}} d 𝓏χ ( 𝓏 ) \hat{D} ( - 𝓏 ) \qquad Eq . ( 9 )$$

the conditional state of the corresponding (idler) signal is:

$$\begin{matrix}{\hat{ρ}}_{I} & ∝ & \int d 𝓏χ ( 𝓏 ) 〈 {q}_{⊓} + {ip}_{⊓} \vert \hat{D} ( - 𝓏 ) \vert {q}_{⊓} + {ip}_{⊓} 〉 & Eq . ( 10 ) \\ & = & \int d 𝓏χ ( {𝓏}_{R} , {𝓏}_{I} ) \times {e}^{- \frac{1}{2} {𝓏}_{R}^{T} {𝓏}_{R} + {i ( Ω {\overline{x}}_{\prod } )}^{T} {𝓏}_{R}} \hat{D} ( - {𝓏}_{I} ) . & Eq . ( 11 ) \\ & & & \end{matrix}$$

Therefore, the output has the characteristic function:

$${χ}_{I} ( ξ ) = \int d {𝓏}_{R} χ ( {𝓏}_{R} , ξ ) {e}^{- \frac{1}{2} {𝓏}_{R}^{T} {𝓏}_{R} + {i ( Ω {\overline{x}}_{\prod } )}^{T} {𝓏}_{R}} \qquad Eq . ( 12 )$$

For Gaussian states, an analytical solution (Eqs. (13a)-(13c)) can be obtained:

$${V}_{A}^{′} = {V}_{A} - {V}_{B} \frac{1}{{V}_{B} + {V}_{\prod }} {V}_{AB}^{T} , \qquad Eq . ( 13 a )$$

$${\overline{x}}_{I}^{′} = {\overline{x}}_{A} {V}_{AB} \frac{1}{{V}_{B} + {V}_{\prod }} ( {\overline{x}}_{\prod } - {\overline{x}}_{B} ) , \qquad Eq . ( 13 b )$$

$$p ( {\overline{x}}_{\prod } ) = \frac{{e}^{- \frac{1}{2} {( {\overline{x}}_{\prod } - {\overline{x}}_{B} )}^{T} \frac{1}{{V}_{B} + {V}_{\prod }} ( {\overline{x}}_{\prod } - {\overline{x}}_{B} )}}{{( 2 π )}^{{K}_{B}} \sqrt{det ( {V}_{B} + {V}_{\prod } )}} , \qquad Eq . ( 13 c )$$

where V_{A} corresponds to a covariance matrix of a subsystem A having K_{A} modes, and V_{B} corresponds to a covariance matrix of a subsystem B having K_{B} modes, where. \hat{x} is a vector operator that includes momentum quadratures [symbol] =( [symbol] + [symbol] ) for [symbol] ∈K and position quadratures [symbol] ₗ=−i( [symbol] − [symbol] ) for [symbol] ∈K.

For non-Gaussian input states, one needs to perform the integral to obtain the output characteristic function. From Eqs. (13a)-(13c), the covariance matrix and mean, and the distribution of measurement outcome for the idler mode of the corresponding (idler) signal are:

$${V}_{I}^{′} = ( 2 \frac{( 1 - κ + {N}_{B} ) {N}_{S}}{κ {N}_{S} + {N}_{B} + 1} + 1 ) , \qquad Eq . ( 14 a )$$

$${\overline{x}}_{I}^{′} = \frac{\sqrt{κ {N}_{S} ( {N}_{S} + 1 )}}{κ {N}_{S} + {N}_{B} + 1} ( cos θ {q}_{⊓} + sin θ {p}_{⊓} + sin θ {q}_{⊓} - cos θ {p}_{⊓} ) \qquad Eq . ( 14 b )$$

$$p ( {\overline{x}}_{\prod } ) = \frac{{e}^{- \frac{{\vert {\overline{x}}_{\prod } \vert}^{2}}{4 ( κ {N}_{S} + {N}_{B} + 1 )}}}{4 π ( κ {N}_{S} + {N}_{B} + 1 )} . \qquad Eq . ( 14 c )$$

One can directly realize that the idler mode is in a displaced thermal state with mean x̅_{I}′ and thermal photon number E=(1−κ+N_{B})N_{S}/(κN_{S}+N_{B}+1), as stated in the previous sections of the present disclosure. Formally, a displaced thermal state of the idler mode with complex mean α and mean thermal photon number E can be defined as:

$${\hat{ρ}}_{α , E} ≡ {\sum }_{n = 0}^{∞} \hat{D} ( α ) \frac{{E}^{n}}{{( 1 + E )}^{n + 1}} \vert n 〉 〈 n \vert {\hat{D}}^{†} ( α ) \qquad Eq . ( 15 )$$

where \hat{D}(α)=exp(αâ†−α*â) is the complex displacement operator acting on a mode â and |n [symbol] is a number state. Note that the complex displacement α= [symbol] â [symbol] = [symbol] \hat{q}+i\hat{p} [symbol] .

Using the distribution of quadratures Eq. (14c), the distribution of the complex heterodyne readout on the mth return mode [symbol] ₘ=(q_{Rm}+ip_{Rm})/2 (e.g., for the (return) signal received at the receiver device 20) can be obtained as:

$$p ( {m}_{} ) = \frac{{e}^{\frac{{\vert {m}_{} \vert}^{2}}{( κ {N}_{s} + {N}_{B} + 1 )}}}{π ( κ {N}_{s} + {N}_{B} + 1 )} . \qquad Eq . ( 16 )$$

At the same time, the complex displacement of the corresponding (idler) signal conditioned on the measurement result is:

$${d}_{m} = \frac{\sqrt{κ {N}_{S} ( {N}_{S} + 1 )}}{κ {N}_{S} + {N}_{B} + 1} {e}^{i θ} {{m}_{}}^{*} \qquad Eq . ( 17 )$$

where [symbol] denotes the complex conjugate.

Through the change of variables, one can write the total displacement amplitude square:

$${\vert {d}_{T} \vert}^{2} ≡ {\sum }_{m = 1}^{M} {\vert {d}_{m} \vert}^{2} = ξ {\sum }_{i = 1}^{2 M} {z}_{i}^{2} , \qquad Eq . ( 18 )$$

$$with$$

$$ξ = κ {N}_{S} ( {N}_{S} + 1 ) / 2 ( κ {N}_{S} + {N}_{B} + 1 ) \qquad Eq . ( 19 )$$

and zᵢ˜ [symbol] (0, 1) being a standard normal random variable, and thus the χ² distribution of |d_{T}|² is:

$${P}_{κ}^{( M )} ( x ) \sim \frac{1}{ξ} {( \frac{x}{ξ} )}^{M - 1} {e}^{- x / ( 2 ξ )} , \qquad Eq . ( 20 )$$

with mean 2Mξ and variance 4Mξ², where ξ≡Cₚ²/4v [symbol] .

At the end of the section, a Gaussian approximation to the distribution Eq. (20) is provided to enable a more efficient numerical simulation when M≥10⁷. First, define Z≡Σᵢ₌₁^{2M}zᵢ²˜χ²(2M). By central limit theorem, at the limit of M>>1, (Z−2M)/\sqrt{4M}˜ [symbol] (0, 1) follows standard normal distribution. Therefore, when M>>1, the distribution:

$${\vert {d}_{T} \vert}^{2} \sim ( 2 M ξ , 4 M {ξ}^{2} ) \qquad Eq . ( 21 )$$

can be approximated as a Gaussian distribution with mean 2Mξ and variance 4Mξ².

### 3.2 Quantum Fisher Information for Phase Sensing

This section provides an evaluation of Quantum Fisher Information (QFI) for phase sensing that can be obtained using the conversion unit 100, where the parameter is the signal phase shift θ.

A displaced thermal state ρ_{\sqrt{xe}}_{^{iθ}}_{,y} of the idler mode defined in Eq. (15) can be characterized with the following mean and covariance matrix:

$$\begin{matrix}d = {[ \sqrt{x} {e}^{i θ} , \sqrt{x} {e}^{- i θ} ]}^{T} , \\ Σ = ( \begin{matrix}0 & y + 1 / 2 \\ y + 1 / 2 & 0\end{matrix} ) .\end{matrix} \qquad Eq . ( 22 )$$

Thus, the QFI for phase sensing:

$${DTS}_{} = \frac{4 x}{1 + 2 y} \qquad Eq . ( 23 )$$

Consider M independent and identically distributed (i.i.d.) probes estimating the lossy channel Φ_{κ,θ} (defined in Eq. (1) of the present disclosure) with thermal noise N_{B}, each with mean photon number N_{S}. For a classical protocol using coherent-state robes |\sqrt{N_{S}} [symbol] , one can observe that the channel output [Φ_{κ,θ}(|\sqrt{N_{S}} [symbol] [symbol] \sqrt{N_{S}}|)]^{⊖M} is a product of displaced thermal states. Then, the M channel outputs can be combined into a single mode in a displaced thermal state by a balanced M-port beamsplitter (e.g., of one or more quantum circuits). This processing does not change the QFI, because the beam-splitter transform is a unitary and the output is again a product state, where the additional noise modes can be discarded. The output state has x=MκN_{S}, y=N_{B}, thus:

$${CS}_{} = \frac{4 M κ {N}_{S}}{1 + 2 {N}_{B}} \qquad Eq . ( 24 )$$

Similarly, for an entanglement-assisted communication protocol using the conversion unit 100 with TMSV probes, the outputs at the idler ports can be combined into a displaced thermal state. The random readouts of heterodyne detection at the signal ports determines the squared mean x of the displaced thermal state to be in the χ² distribution P_{κ}^{(M)}(x) defined as Eq. (20). Thus:

$${C \to D}_{} ≡ \int dx {P}_{κ}^{( M )} ( x ) {θ}_{} ( {\hat{ρ}}_{{e}^{i θ} \sqrt{x} , E} ) = \frac{8 M ξ}{1 + 2 E} \qquad Eq . ( 25 )$$

where

$${θ}_{} ( {\hat{ρ}}_{e \sqrt{x} , E}^{{}_{{}_{i θ}}} ) = 4 x / ( 1 + 2 E )$$

is the QFI of the displaced thermal state conditioned on a specific x. Plugging the definitions of ξ, E in Section 2 of the present disclosure, the following can be obtained:

$${C \to D}_{} = \frac{4 M κ {N}_{S} ( {N}_{S} + 1 )}{1 + {N}_{B} + {N}_{S} ( 2 {N}_{B} + 2 - κ )} \qquad Eq . ( 26 )$$

At the neighborhood of true value, the QFI of a displaced thermal state is achieved by homodyne measurement. This can be seen as follows. For

$$\hat{ρ} \sqrt{x} {e}^{i ( θ + {θ}_{c} )} , y .$$

suppose a phase rotation of angle θ_{c} is first applied—the state becomes

$$\hat{ρ} \sqrt{x} {e}^{i θ} , y ,$$

Then homodyne detection is applied, giving the random readout Q subject to the distribution:

$${p}_{Q} = \frac{1}{\sqrt{2 {πσ}^{2}}} exp \{ - \frac{{( Q - \sqrt{2} Re ( d ) )}^{2}}{2 {σ}^{2}} \} \qquad Eq . ( 27 )$$

where σ²=1/2+y, d=\sqrt{x}e^{iθ}. Thus the Fisher information of homodyne measurement, depending on a phase compensation θ_{c}, can be calculated from the distribution as:

$${hom}_{} ( x , E , θ ) = \frac{4 x}{1 + 2 y} {sin}^{2} ( θ + {θ}_{c} ) . \qquad Eq . ( 28 )$$

As shown, homodyne measurement achieves the QFI in Eq. (23) locally, which is true only when the prior knowledge is sufficient such that (θ+θ_{c}) is close to π/2, while its performance decays rapidly when θ_{c} deviates from the ideal compensation π/2−θ. When prior knowledge is insufficient, an adaptive policy can be designed to approach the ideal compensation, as the number of available probes is sufficiently large.

It is worthwhile to note that the conversion unit 100 is optimal for TMSV-based phase estimation: it achieves the QFI of the channel output of TMSV sources:

$${TSMV}_{} = \frac{4 M κ {N}_{S} ( {N}_{S} + 1 )}{1 + {N}_{B} ( 1 + 2 {N}_{S} ) {N}_{S} ( 1 - κ )} \qquad Eq . ( 29 )$$

at the limit of N_{B}<<1

### 3.3 Entanglement-Assisted Communication Rate Analyses

This section evaluates the Holevo information of the output ensemble of the conversion unit 100, using a phase-encoded TMSV source. The Holevo information is a tight upper bound on the information rate of a channel given a specific encoding ensemble {p_{θ}, \hat{ρ}_{θ}}, which is achieved by the optimum receiver. The ultimate capacity can be obtained by optimizing the Holevo information over {p_{θ}, \hat{ρ}_{θ}}. In general, θ can be an arbitrary parameter, while in this scenario θ can be specified as the phase shift as is useful for practical phase-sensing purposes. Consider repetition coding that yields M i.i.d. copies of the output ensemble. Given θ, the output state is

$${\hat{ρ}}_{\sqrt{X} {e}^{i θ} , E}$$

defined by Eq. (15), where X is a random readout under χ² distribution defined in Eq. (20). Let the encoding phase be a random variable Θ subject to probability distribution P_{Θ} with the output quantum system denoted as O. In the communication protocol, the readouts X, the output quantum system O along with the input symbol Θ are in a classical-quantum state:

$${{{\hat{σ}}_{XO Θ} = \int d θ {p}_{Θ} ( θ ) \int d x {P}_{κ}^{( M )} ( x ) \vert x 〉 〈 x \vert}_{X} ⊗ {( {\hat{ρ}}_{\sqrt{x} {e}^{i θ} , E} )}_{O} ⊗ \vert θ 〉 〈 θ \vert}_{Θ} . \qquad Eq . ( 30 )$$

The overall Holevo information about the input symbol is:

$${χ}_{{}_{C \to D}} ≡ \frac{1}{M} [ {S ( XO )}_{\hat{σ}} - {S ( XO \vert Θ )}_{\hat{σ}} ] = \frac{1}{M} \int {dxp}_{X} ( x ) [ {S ( O \vert X = x )}_{\hat{σ}} - {S ( O \vert Θ , X = x )}_{\hat{σ}} ] = \frac{1}{M} \int d x {P}_{κ}^{( M )} ( x ) χ ( \{ {p}_{Θ} , {\hat{ρ}}_{\sqrt{x} {e}^{i Θ} , E} \} ) . \qquad Eq . ( 31 )$$

The second equality is due to the joint entropy theorem given the orthogonality of {|x [symbol] _{X}}. Here

$$χ ( \{ {p}_{Θ} , {\hat{ρ}}_{\sqrt{X} {e}^{i Θ} , E} \} )$$

can be efficiently evaluated in the following example.

Consider a communication scenario involving continuous PSK (CPSK) modulation on TMSV sources with P_{Θ}(θ)=1/2π, θ∈[0, 2π). The output ensemble of the conversion unit 100 yields the Holevo information:

$$χ ( {P}_{Θ} , {\hat{ρ}}_{\sqrt{x} {e}^{i Θ} , E} ) = S ( \int d θ {P}_{Θ} ( θ ) {\hat{ρ}}_{\sqrt{x} {e}^{i θ} , E} ) - \int d θ {P}_{Θ} ( θ ) S ( {\hat{ρ}}_{\sqrt{x} {e}^{i θ} , E} ) = H [ \{ P ( n \vert X = x ) \} ] - g ( E ) . \qquad Eq . ( 32 )$$

The third line of Eq. (*32) follows from the following. The conditional states

$$\{ {\hat{ρ}}_{\sqrt{x} {e}^{i θ} , E} \} .$$

are Gaussian states with identical entropy,

$$S ( {\hat{ρ}}_{\sqrt{x} {e}^{i θ} , E} ) = g ( E ) ,$$

where g(n)=(n+1) log₂(n+1)−n log₂n is the entropy of a thermal state with mean photon number n. Thus

$$\int d θ {P}_{Θ} ( θ ) S ( {\hat{ρ}}_{\sqrt{x} {e}^{i θ} , E} ) = g ( E ) .$$

Meanwhile, the unconditional state

$$\int d θ {P}_{Θ} ( θ ) {\hat{ρ}}_{\sqrt{x} {e}^{i θ} , E} )$$

is completely de-phased due to [0, 2π) uniform phase encoding thus its eigenbasis is the photon number Fock basis. Its distribution on the Fock basis is:

$$P ( n \vert X = x ) = {{E}^{n} ( E + 1 )}^{- n - 1} {e}^{- \frac{x}{E + 1}} {L}_{n} ( - \frac{x}{E ( E + 1 )} ) \qquad Eq . ( 33 )$$

where Lₙ(x) is the nth Laguerre polynomial. Thus, the unconditional entropy reduces to the Shannon entropy of the photon number distribution:

$$H [ \{ P ( n \vert X = x ) \} ] ≡ - {\sum }_{n = 0}^{∞} P ( n \vert X = x ) log ( P ( n \vert X = x ) ) . \qquad Eq . ( 34 )$$

Combining Eqs. (31) and (32), the Holevo information for CPSK is:

$${χ}_{{}_{C \to D}}^{CPSK} = \frac{1}{M} [ \int d x {P}_{κ}^{( M )} ( x ) H [ \{ P ( n \vert X = x ) \} ] - g ( E ) ] \qquad Eq . ( 35 )$$

Eq. (35) can be adopted for efficient numerical evaluation. At the limit M→∞, x converges to 2Mξ with probability by law of large numbers. Then a closed-form formula can be obtained:

$${χ}_{{}_{C \to D}}^{CPSK} = \frac{1}{M} [ H [ \{ P ( n \vert X = 2 M ξ ) \} ] - g ( E ) ] = \frac{κ {N}_{s} [ ln ( \frac{1}{{N}_{s}} ) + {C \to D}_{} ]}{( {N}_{B} + 1 ) ln 2} + O ( {N}_{S}^{2} ) = \frac{κ {N}_{s} ln ( \frac{1}{{N}_{s}} )}{( {N}_{B} + 1 ) ln 2} + O ( {N}_{s} ) \qquad Eq . ( 36 )$$

where

$${C \to D}_{} = \frac{2 ( - {N}_{B} + κ - 1 )}{κ M} tan {h}^{- 1} ( \frac{κ M}{2 {N}_{B} - 2 κ + κ M + 2 )} )$$

is independent on N_{S}. The last two lines expand at the N_{S}→0 limit. Here, |O(x)|/x<∞ as x→0.

Note that the above scaling at N_{S}→0 saturates the EA classical capacity, and therefore is asymptotically optimal. At the same time, the information per symbol is strictly higher than the case of M>>1, therefore the optimal scaling applies to any finite M.

One may follow a similar route to solve a binary PSK (BPSK) communication scenario, where P_{θ}(0)=P_{Θ}(π)=1/2. The conditional entropy is the same as that in the CPSK,

$$S ( {\hat{ρ}}_{\sqrt{x} {e}^{i θ} , E} ) = g ( E ) .$$

The evaluation of the unconditional entropy is more challenging: it is now a Von Neumann entropy where eigenvalues of the density operator

$$\hat{\overline{ρ}} = \int d θ {P}_{Θ} ( θ ) {\hat{ρ}}_{\sqrt{x} {e}^{i θ} , E}$$

to be solved. Nevertheless, a closed-form formula is still available at the limit of M>>1 (such that x→2Mξ) and N_{S}→0. Indeed, the performance of BPSK is almost identical to the CPSK case in the parameter region of FIGS. 5A and 5B. Below, the eigenvalues are approximated via matrix perturbation theory. Consider the representation in Fock basis:

$$Eq . ( 37 )$$

$${ρ}_{m n} = 〈 m \vert \hat{\overline{ρ}} \vert n 〉 = \frac{\sqrt{m !} {E}^{n} {\vert x \vert}^{( m - n ) / 2} {}_{1} {\tilde{F}}_{1} ( m + 1 ; m - n + 1 ; \frac{x}{{E}^{2} + E} ) {e}^{- \frac{x}{E} + i θ ( m - n )}}{{( E + 1 )}^{m + 1} \sqrt{n !}}$$

where ₁\tilde{F}₁(a; b; z) is the regularized confluent hypergeometric function. In the numerical evaluation, p is truncated in finite dimension d×d.

In the final approximation of eigenvalues, the infinitesimal terms can be kept up to O(N_{S}) . . . d=3 was found to be sufficient. Now, a Taylor expansion can be applied to each matrix entry ρₘₙ as:

$${ρ}_{mn} = {\tilde{ρ}}_{mn} + δ {ρ}_{mn} \qquad Eq . ( 38 )$$

where the approximation \tilde{ρ}ₘₙ˜O(N_{S}^{d}) omits higher order term δPₘₙ˜O(Nd*¹)

With d=3, the eigenvalues of \tilde{ρ} can be solved analytically, and thus the Holevo information is:

$$\begin{matrix}{χ}_{C \to E}^{BPSK} = \frac{1}{M} [ S ( ρ ) - g ( E ) ] + O ( {δ}_{d} ) \\ = \frac{κ {N}_{S} [ ln ( \frac{1}{{N}_{S}} ) + {ℛ}_{C \to D} ]}{( {N}_{B} + 1 ) ln 2} + O ( {δ}_{{N}_{S}} ) + O ( {δ}_{d} ) \\ = \frac{κ {N}_{S} ln ( \frac{1}{{N}_{S}} )}{( {N}_{B} + 1 ) ln 2} + O ( {N}_{S} ) + O ( {δ}_{{N}_{S}} ) + O ( {δ}_{d} ) ,\end{matrix} \qquad Eq . ( 39 )$$

where δ_{d} is the maximal error in eigenvalues from the matrix truncation and δ_{N}_{_{S}} is from the matrix Taylor expansion, the residue [symbol] _{C→D} is the same as that defined
below the CPSK case Eq. (36). The leading term of the matrix Taylor expansion at the second equality coincides with Eq. (36).

At last, the errors δ_{d}, δ_{N}_{_{S}} in Eq. (39) are analyzed.

First, consider δ_{d}. Define the true eigenvalues of the operator [symbol] as μ₁≥μ₂≥ . . . and the eigenvalues of the truncated representation ρ as λ₁≥λ₂≥ . . . ≥λ_{d}. Then δ_{d}≡max_{i∈[da]}|μᵢ−λᵢ|, and:

$$\vert {δ}_{d} \vert = {‖ diag ( {μ}_{i} - {λ}_{i} ) ‖}_{2} \leq {‖ X ‖}_{2} \qquad Eq . ( 40 )$$

where X=ρ^{(∞)}I_{d}−I_{d}ρ, I_{d} is a d×d matrix representation of projector that implements the cutoff, ρ^{(∞)} is the exact infinite-dimensional matrix representation of the operator [symbol] . Here the matrix 2-norm is defined using vector 2-norm: for d×d matrix A∈ [symbol] , ∥Aμ₂≡sup_{x≠0}∥Ax∥₂/∥x∥₂, ∀x∈ [symbol] . Observe that the 2-norm∥X∥₂=O(N_{S}^{d/2}). Thus d=3 is sufficient to suppress the error to O(N_{S}^{3/2}).

Next, consider δ_{N}_{_{S}}. Define the eigenvalues of ρ as {λᵢ}ᵢ₌₁^{d}, and the eigenvalues of \tilde{ρ} as {\tilde{λ}ᵢ}ᵢ₌₁^{d}. The error in eigenvalues is equal to the Hausdorff distance |δ_{N}_{_{S}}|≡maxᵢ|\tilde{λ}ᵢ−λᵢ|=hd(ρ, \tilde{ρ}), when the perturbation is small such that the eigenvalues are still pairwise matched: j=argminⱼ,|\tilde{λ}₁−λⱼ|. Note that ∥δ_{ρ}|₂=O(N_{S}^{d+1}). According to Elsner's theorem, the error is upper bounded by

$$\vert {δ}_{{N}_{S}} \vert \leq {( {‖ ρ ‖}_{2} + {‖ \tilde{ρ} ‖}_{2} )}^{1 - 1 / d} {‖ {δ}_{ρ} ‖}_{2}^{1 / d} = O ( {N}_{S}^{1 + 1 / d} ) , \qquad Eq . ( 41 )$$

which is much smaller than O(N_{S}). Finally, the overall error |δ_{d}|+|δ_{N}_{_{S}}|<<O(N_{S}) when d=3, N_{S}→0.

### 4. Performance of Conversion Unit in the Presence of Noise

In practical quantum illumination applications, targets often induce a random return phase; moreover, their reflectivities can have fluctuations obeying a Rayleigh-distribution. This section extends the analyses of the conversion unit 100 to realistic targets in the presence of noise and while maintaining advantages of entanglement. In particular, the conversion unit 100 allows exact and efficient performance evaluation despite the non-Gaussian nature of the quantum channel involved.

Take target detection as an example, the transceiver-to-receiver path in presence of a distant target can be modeled as a Gaussian thermal-loss channel with low transmissivity; when the target is absent, the thermal-loss channel degrades to its zero-transmissivity limit. In a quantum illumination (QI) protocol with a common Gaussian entangled source of two-mode squeezed vacuum, the error probability performance limit can be obtained via the efficiently calculable quantum Chernoff bound (QCB), which enables the surprising discovery of a six-decibel error exponent advantage over classical illumination (CI) despite loss and noise.

Things become challenging when non-Gaussian elements are inevitably involved. To begin with, although the channel and source are Gaussian, receivers based on only Gaussian operations (e.g., optical-parametric amplification and phase conjugation) are only able to achieve half of the error exponent advantage. Previously proposed optimal receiver design relies on complex non-Gaussian operations that forbid exact performance evaluations. Moreover, a practical target detection scenario involves fading targets, where the random phase noise and fluctuating reflectivity make the quantum channel non-Gaussian. The non-Gaussian nature of the problem makes it difficult to evaluate entanglement's advantage in detecting fading targets.

The conversion unit 100 disclosed herein reduces multi-mode correlated state detection to single-mode coherent-state detection, enabling optimal receiver design and efficient evaluation even when non-Gaussian elements are involved. Results show that when there is only correlated phase noise across the probing, the error probability still decays exponentially with the number of probing. Entanglement's error-exponent advantage is still found to be about six-decibel when the signal brightness is extremely small, but degrades as the brightness increases. Such robustness resembles previous findings in the communication case. In the presence of transmissivity fluctuation of the Rayleigh type, however, the error probability decays polynomially with the number of probing probes, and the advantage from entanglement is small, despite being non-zero.

### 4.1 Model for Fading Target Detection

Referring again to FIG. 1A, in an entanglement-assisted QI target detection scenario, the probe signal (e.g., the quantum-entangled and/or quantum-correlated signal including a primary signal and an idler signal) sent from the transmitter device 10 is entangled with an ancilla. The probe signal is reflected by a stationary target in a highly lossy and noisy environment before being detected at the receiver device 20 in the form of a quantum-entangled and/or quantum-correlated signal having a (return) signal and a corresponding (idler) signal. As before, the (return) signal received at the receiver device 20 corresponds to the primary signal sent by the transmitter device 10 and the corresponding (idler) signal received at the receiver device 20 corresponds to the idler signal sent by the transmitter device 10. The receiver device 20 must be properly structured required to measure the quantum-entangled and/or quantum-correlated signal and the ancilla to boost the sensing precision over CI. In the ideal case of a known phase and a fixed target reflectivity, this process can be modeled as an overall phase-shift thermal-loss channel φ_{κ,θ}, with κ being the transmissivity and θ being the phase shift (as shown in FIG. 7, which shows application of the conversion unit 100 to a noisy target detection scenario). For an input mode described by the annihilation operators âₛ, the received mode can be modeled by Eq. (1) above where the mode â_{B} is in a thermal state with mean photon number N_{E} to model noise.

To model a realistic setting, consider a target with a time-independent P_{K}(·)-distributed random reflectivity and P_{θ}(·)-distributed random phase shift. This leads to the overall quantum channel:

$$\overline{Φ} = \int d θ d κ {P}_{Θ} ( θ ) {P}_{K} ( κ ) {Φ}_{κ , θ} . \qquad ( 42 )$$

The target detection hypothesis testing problem is therefore a quantum channel discrimination problem between the channel ϕ̅ (fading target present) and a pure noise channel Φ_{0,0}.

To benefit from entanglement in QI, consider M signal-idler pairs {â_{S}_{ₘ}, â_{I}_{ₘ}}ₘ₌₁^{M}, where each pair is in a two-mode squeezed-vacuum (TMSV) state with the wave-function:

$${{\hat{ϕ} {S}_{m} {I}_{m} = {\sum }_{n = 0}^{∞} \sqrt{\frac{{N}_{S}^{n}}{{( {N}_{S} + 1 )}^{n + 1}}} \vert n 〉}_{{S}_{m}} \vert n 〉}_{{I}_{m}} . \qquad ( 43 )$$

Here |n [symbol] is the number state and N_{S} is the mean photon number of the signal (or idler) mode.

When the target is present, after the channel φ̅, the density operator of the return and idler field is:

$${\hat{ρ}}_{RI} = \int d θ d κ {P}_{Θ} ( θ ) {P}_{K} ( κ ) {\hat{ρ}}_{RI} ( θ , κ ) . \qquad ( 44 )$$

Here the state \hat{ρ}_{RI}(θ, κ) describes the M return-idler pairs {â_{R}_{ₘ}, â_{I}_{ₘ}}ₘ₌₁^{M}, from channel Φ_{κ,θ}, each maintaining a phase-sensitive cross-correlation correlation [symbol] â_{S}_{ₘ},â_{I}_{ₘ} [symbol] =e^{iθ}Cₚ with the amplitude Cₚ≡\sqrt{κN_{S}(N_{S}+1)}.

### 3.2 Analyses of Correlation-To-Displacement Conversion Unit

FIG. 7 shows application of the conversion unit 100 to a QI target detection scenario in the presence of noise. As discussed, the conversion unit 100 performs heterodyne measurement on each return mode (e.g., on the (return) signals) and retains the idlers (e.g., the corresponding (idler) signals) for further information processing. In general, the measurements obtained by the conversion unit 100 can be described by positive operator-valued measure (POVM) elements Êₓ^{†}Êₓ satisfying the completeness relation ∫d^{2M}xÊₓ^{†}Êₓ=Î, where the overall measurement result across the M returns x=(x₁, . . . , x_{M})^{T} with each x_{M} being complex.

The corresponding probability of having measurement result X=x is given by:

$$\begin{matrix}{P}_{X} ( x ) = Tr ( {\hat{ρ}}_{RI} {\hat{E}}_{x}^{†} {\hat{E}}_{x} ) \\ = \int d θ d κ {P}_{Θ} ( θ ) {P}_{K} ( κ ) {P}_{X \vert Θ , K} ( x \vert θ , κ ) ,\end{matrix} \qquad \begin{matrix}( 45 ) \\ ( 46 )\end{matrix}$$

With P_{X|Θ,K}(x|θ, κ)=Tr(\hat{p}_{RI}(θ,κ)Êₓ^{†}Êₓ) as the conditional probability when the channel is Φ_{κ,θ}. For a given fixed phase and reflectivity such as in the analyses provided above, the distribution is modeled by a complex Gaussian distribution with variance 2σ_{κ}²=κN_{S}+(1−K)N_{E}+1, i.e.,

$${P}_{x \vert Θ , K} ( x \vert θ , κ ) = g ( \vert x \vert , {σ}_{k} ) , \qquad ( 47 )$$

where g(x,σ)=e^{-x}^{²}^{/2σ}^{²}/(2πσ²)^{M}. Note that P_{X|Θ,K}(x|θ, κ) does not depend on the phase shift θ; therefore, the unconditional distribution of the measurement result is obtained as:

$${P}_{X} ( x ) = \int d κ {P}_{K , X} ( κ , x ) , \qquad ( 48 )$$

with P_{K,X}(κ,x)≡P_{K}(κ)P_{X|Θ,K}(x|θ,κ)=P_{K}(K)g(|x|,σ_{κ}). At the same time, the conditional distribution can be obtained as:

$${P}_{K \vert X} ( κ \vert x ) = \frac{{P}_{K} ( κ ) g ( \vert x \vert , {σ}_{k} )}{\int d κ {P}_{K} ( κ ) g ( \vert x \vert , {σ}_{k} )} ≡ f ( κ , \vert x \vert ) , \qquad ( 49 )$$

which is only a function of the module |x| and κ.

Conditioned on the measurement result of the return mode (e.g., the (return) signal), the signal-idler joint state can be projected to:

$$\begin{matrix}{\hat{ρ}}_{RI}^{′} ( x ) = \frac{{\hat{E}}_{x} {\hat{ρ}}_{R I} {\hat{E}}_{x}^{†}}{{P}_{X} ( x )} \\ = \int d θ d κ \frac{{P}_{Θ} ( θ ) {P}_{K , X} ( κ , x )}{{P}_{X} ( x )} {\hat{ρ}}_{RI} ( θ , κ \vert x ) ,\end{matrix} \qquad \begin{matrix}( 50 ) \\ ( 51 )\end{matrix}$$

where the conditional state:

$${\hat{ρ}}_{R I} ( θ , κ \vert x ) = \frac{{\hat{E}}_{x} {\hat{ρ}}_{RI} ( θ , κ ) {\hat{E}}_{x}^{†}}{{P}_{X \vert Θ , K} ( x \vert θ , κ )} \qquad ( 52 )$$

is identical to the return state after the heterodyne detection, when the target has a fixed phase shift θ and a reflectivity κ. Therefore, the corresponding (idler) modes of \hat{ρ}_{RI}(θ, κ|x) are in product of displaced thermal state:

$$T {r}_{R} [ {\hat{ρ}}_{R I} ( θ , κ \vert x ) ] = {⊗}_{m} {\hat{ρ}}_{{d}_{m} , {E}_{κ}} . \qquad ( 53 )$$

The complex displacement of the corresponding (idler) signal conditioned on the measurement result of the (return) signal is

$${d}_{m} = {μ}_{κ} {e}^{i θ} {x}_{m}^{*} ,$$

with:

$${μ}_{κ} = \frac{\sqrt{κ {N}_{S} ( {N}_{S} + 1 )}}{[ κ {N}_{S} + ( 1 - κ ) {N}_{E} + 1 ]} , \qquad ( 54 )$$

and the thermal noise mean photon number:

$${E}_{κ} = \frac{( 1 - κ ) ( 1 + {N}_{E} ) {N}_{S}}{[ κ {N}_{S} + ( 1 - κ ) {N}_{E} + 1 ]} . \qquad ( 55 )$$

Conditioned on phase θ and reflectivity κ, one can apply the beamsplitter array strategy outlined above on the corresponding (idler) modes with the weights of the beamsplitter properly chosen based on the heterodyne detection result (independent of κ or θ), producing a one-mode displaced thermal state with the complex displacement,

$$d = \sum {ω}_{m} {d}_{m} = {μ}_{κ} {e}^{i θ} \vert x \vert ,$$

where the weight ωₘ=xₘ/|x| is independent of κ, θ. The mean photon number of the displaced thermal state is still E_{κ}. Considering the phase shift and reflectivity distribution, the unconditional output state of the single output mode is:

$${\hat{ρ}}_{I} ( x ) = \int d κ {P}_{K \vert X} ( κ \vert x ) {\hat{ρ}}_{I , κ} ( x ) . \qquad ( 56 )$$

where the conditional state:

$${\hat{ρ}}_{I , κ} ( x ) ≡ \int d θ {P}_{θ} ( θ ) {\hat{ρ}}_{{μ}_{κ} {e}^{i θ} \vert x \vert , {E}_{κ}} . \qquad ( 57 )$$

Note that when the phase is uniform random in [0,2π), \hat{ρ}_{I,κ}(x) is photon-number diagonal. Similar to Eq. (3), the error probability performance limit of QI based on the conversion unit 100 is therefore:

$${P}_{C \to D} = \int {d}^{2 M} x {P}_{X} ( x ) {P}_{H} [ {\hat{ρ}}_{0 , {N}_{S}} , {\hat{ρ}}_{I} ( x ) ] . \qquad ( 58 )$$

Noticing that the state \hat{ρ}_{I}(x) and the distribution P_{X}(x) are only functions of the amplitude lxi and making use of Eqs. (49) and (47) explicitly, the result can be simplified by integrating out 2M−1 degree of freedom to obtain:

$${P}_{C \to D} = \int d x {P}_{X} ( x ) {P}_{H} [ {\hat{ρ}}_{0 , {N}_{S}} , {\hat{ρ}}_{I} ( x ) ] \qquad ( 59 )$$

Here:

$${P}_{X} ( x ) = \frac{2 {π}^{M}}{Γ ( M )} \int d κ {P}_{K} ( κ ) {x}^{2 M - 1} g ( x , {σ}_{k} ) . \qquad ( 60 )$$

is the distribution of the module of measurement result x, and the corresponding conditional state:

$${\hat{ρ}}_{I} ( x ) = \int d θ d κ {P}_{Θ} ( θ ) f ( κ , x ) {\hat{ρ}}_{{μ}_{K} {e}^{t θ} x , {E}_{κ}} . \qquad ( 61 )$$

### 3.2 Performance for Random Phase Model (Known Reflectivity)

### 3.3 a) Evaluating the Performance of the Conversion Unit

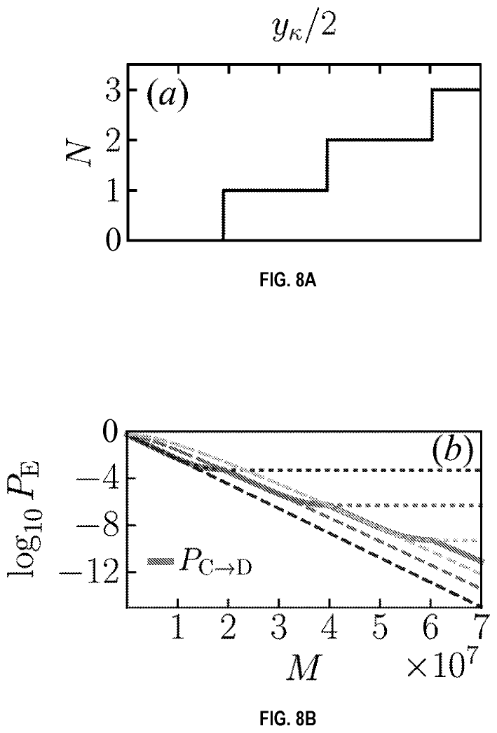

To understand the effect of phase noise on the accuracy of the conversion unit 100, this analysis begins with the scenario of uniformly distributed phase shift and a fixed known reflectivity κ. Results are shown in FIGS. 8A and 8B. The phase noise distribution P_{Θ}(θ)=1/2π and the reflectivity can be modeled as a delta-function, P_{K}(κ′)=δ(κ′−κ). Consequently, \hat{ρ}_{I}=\hat{ρ}_{I,κ} in Eq. (56) is diagonal in the number basis regardless of the target's presence or absence. Therefore, photon counting is the optimal measurement and the error probability performance limit can be analytically solved from Eq. (59) and Eq. (60),

$${P}_{C \to D} = \int d {y}_{κ} {P}_{{χ}^{2}}^{( 2 M )} ( {y}_{κ} ) ( {P}_{H} ) [ {\hat{ρ}}_{0 , {N}_{s} {\hat{ρ}}_{I , κ}} ( {σ}_{κ} \sqrt{{y}_{κ}} ) ] \qquad ( 62 )$$

where

$${P}_{{χ}^{2}}^{( 2 M )} ( \cdot )$$

is the χ² distribution of 2M degrees of freedom and the variable x has been updated to y_{κ}=x²/σ_{κ}² from Eq. (59). At the same time, the following can be explicitly solved:

$${P}_{H} [ {\hat{ρ}}_{0 , {N}_{S}} , {\hat{ρ}}_{I , κ} ( {σ}_{κ} \sqrt{{y}_{κ}} ) ] = [ 1 - {\sum }_{n : {γ}_{n , κ} ( {y}_{κ} ) > 0} {γ}_{n , κ} ( {y}_{κ} ) ] / 2 , \qquad ( 63 )$$

where:

$${Y}_{n , κ} ( {y}_{κ} ) = \frac{{N}_{s}^{n}}{{( 1 + {N}_{s} )}^{n + 1}} - \frac{{E}^{n}}{{( 1 + E )}^{1 + n}} {e}^{- {ξ}_{κ} {y}_{κ} / E} {}_{1} {\tilde{F}}_{1} [ n + 1 , 1 , \frac{{ξ}_{κ} {y}_{κ}}{E ( 1 + E )} ] , \qquad ( 64 )$$

and the summation includes all positive values of γₙ(y). Here ₁\tilde{F}₁ is the regularized confluent hypergeometric function and:

$${ξ}_{κ} = {μ}_{κ}^{2} {σ}_{κ}^{2} = \frac{κ {N}_{S} ( {N}_{S} + 1 )}{2 [ κ {N}_{S} + ( 1 - κ ) {N}_{E} + 1 ]} . \qquad ( 65 )$$

Moreover, due to M>>1, the χ² distribution in Eq. (62) can be approximated as a delta function, and the analytical result can be expressed as:

$${P}_{C \to D} \approx {P}_{H} [ {\hat{ρ}}_{0 , {N}_{S}} , {\hat{ρ}}_{I , κ} ( {σ}_{κ} \sqrt{2 M} ) ] = [ 1 - {\sum }_{n : {γ}_{n , κ} ( 2 M ) > 0} {γ}_{n , κ} ( 2 M ) ] / 2 , \qquad ( 66 )$$

The above expression has been numerically verified and agrees with the exact result with negligible error in all the parameter regions.

FIG. 8B plots QI performance P_{C→D} as the red curve. Abrupt changes are visible in the error probability when the number of modes M increases, due to the integer summation in Eq. (67). To better understand the performance, consider a threshold decision strategy, where one compares the measured photon number against a threshold N: target presence is declared if and only if the photon number is larger than N. From Eq. (67), the error probability of such a threshold decision is:

$${P}_{C \to D , κ}^{N} = \frac{1}{2} [ 1 - {\sum }_{n = 0}^{N} {Y}_{n , κ} ( 2 M ) ] . \qquad ( 68 )$$

P_{C→D,κ}^{N} is plotted as the dotted lines for different values of N and they agree with P_{C→D} within each continuous sector (solid curve). The abrupt changes of P_{C→D} also corresponds well with the change in the optimal decision threshold argmin_{N} P_{C→D,κ}^{N} in FIG. 8A.

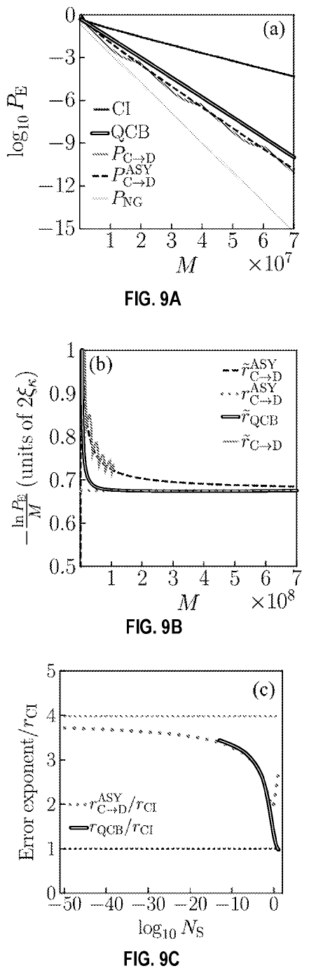

After understanding the performance enabled by the conversion unit, this section (with additional reference to FIG. 9A) compares the QI error probability P_{C→D} of Eq. (67) with that of CI to show the entanglement's advantage. In CI with coherent-state probes, due to the uniform random phase noise, the received state is photon-number diagonal, and the Helstrom limit can be efficiently evaluated. P_{C→D} (darker gray solid) is shown in FIG. 9A in comparison with the error probability of CI (black solid) and showing orders of magnitude advantage. In particular, the curves indicate that QI and CI still have different error exponents despite the fully random phase noise, as shown in the next section with asymptotic analyses.

### 3.3 B) Asymptotic Results and Error Exponent

To better understand the QI performances of the conversion unit 100, and in particular to understand the error exponent in presence of the random phase noise, this section explores asymptotic solutions of P_{C→D}. Considering Eqs. (66) and (57) at the low brightness (N_{S}<<1) and low reflectivity (κ<<1) limit, the noisy displaced coherent state in Eq. (57) can be approximated as a coherent state and \hat{ρ}_{0,N}_{_{S}} as a vacuum state. Therefore, Eq. (64) can be approximated as

$${γ}_{n , κ} ( {y}_{κ} ) = {δ}_{n , 0} - {{e}^{- {ξ}_{κ} {y}_{κ}} ( {ξ}_{κ} {y}_{κ} )}^{n} / n ! ,$$

where δ_{n,0} is the Kronecker delta function.

Given a threshold N, from Eq. (68), the error probability of the conversion unit 100 in large-M limit is

$${P}_{C \to D , κ}^{N} \approx \frac{1}{2} {\sum }_{n = 0}^{N} {p}_{n} with {p}_{n} = {{e}^{- 2 {ξ}_{κ} M} ( 2 ξ M )}^{n} / n ! \qquad ( 69 )$$

and the minimum error probability P_{C→D}=min_{N} P_{C→D,κ}^{N}. When the photon number threshold N=0, it is just the error probability of Kennedy receiver and P_{C→D,κ}⁰=(1/2)e^{-2ξ}^{_{κ}}^{M}. The dashed lines in FIG. 8B show the approximated error probabilities for the decision threshold N=0,1,2, respectively. A good recovery of the P_{C→D} (solid curve) in each continuous sector is visible, which enables proceeding with the asymptotic analyses.

Next, the asymptotic optimal decision threshold is obtained. Consider Eq. (66), \hat{ρ}_{0,N}_{_{S}} can be treated as thermal state again. Its density matrix is diagonal, with elements pₙ′=N_{S}ⁿ/(1+N_{S})n+1. The optimal threshold is determined by solving P_{N}=p_{N}′, where p_{N} is defined in Eq. (69), to obtain:

$$N \approx \frac{2 {ξ}_{κ} M}{ϵ} , \qquad ( 70 )$$

where ϵ=−W₋₁(−N_{S}/e)>>1 and W₋₁ is Lambert W function. The approximation holds when M>>1. An asymptote of the Helstrom limit P_{C→D}^{ASY} can be obtained by substituting Eq. (70) into Eq. (69) and its error exponent can be obtained as:

$${r}_{C \to D}^{ASY} = {lim}_{M \to ∞} {\tilde{r}}_{C \to D}^{ASY} ( M ) = [ 1 - ln ( e ϵ ) / ϵ ] 2 {ξ}_{κ} , \qquad ( 71 )$$

where the finite-M exponent is defined as:

$${\tilde{r}}_{C \to D}^{ASY} ≡ - ln {P}_{C \to D}^{ASY} ( M ) / M . \qquad ( 72 )$$

Now, P_{C→D}^{ASY} is shown in FIG. 9A by the black dashed curve. Indeed, there is a good agreement with P_{C→D} of Eq. (67) (darker gray solid). To understand the error exponent, the error probability is plotted in a logarithmic version −ln P_{E}/M in units of 2ξ_{κ} (see Eq. (65)) with respect to the number of modes M in FIG. 9B. As expected, \tilde{r}_{C→D}^{ASY} (black dashed) approaches r_{C→D}^{ASY} (circular dotted) in the large M limit. The exact results P_{C→D} (darker gray solid) agrees well with \tilde{r}_{C→D}^{ASY}, however, its evaluation is limited to rather small M due to numerical precision constraints.

With the error exponent P_{C→D}^{ASY} in hand, the error exponent of CI r_{CI}=lim_{M→∞}−ln(P_{CI})/M can be compared to understand the quantum advantage in the error exponent under different signal brightness. As shown in FIG. 9C, r_{C→D}^{ASY} (circular dotted solid) is always larger than r_{CI}, confirming quantum advantage, moreover, the error exponent ratio approaches six decibels (indicated by the upper dotted line) as N_{S} approaches zero, although the rate of convergence is very slow. This can be confirmed analytically from Eq. (71) via:

$${lim}_{{N}_{S \to 0}} {r}_{C \to D}^{ASY} = 2 {ξ}_{κ} ≃ κ {N}_{S} / {N}_{E} \qquad ( 73 )$$

As r_{CI}≤κN_{S}/4N_{E}, there is indeed a six-decibel advantage of QI over CI. Based on the numerical results as well as asymptotic analyses, in the weak signal limit, phase noise essentially does not change the error exponent, compared to the case without phase noise.

### 3.3c) Upper and Lower Bounds

Finally, additional comparison of the QI performance of the conversion unit 100 with upper and lower bounds is provided in this section. An upper bound is obtained from the asymptotically tight QCB and a lower bound is obtained from the Nair-Gu (NG) bound.

Given any two quantum state \hat{ρ}₀, \hat{ρ}₁, the QCB P_{QCB} (\hat{ρ}₀, \hat{ρ}₁)=(1/2) inf_{S∈[0,1]}Q_{S}, where Q_{S}=Tr(\hat{ρ}₀^{s}\hat{ρ}₁^{1-s}), is an asymptotically tight upper bound for the Helstrom limit P_{H}[\hat{ρ}₀,\hat{ρ}₁]. Therefore, for the uniform phase and known reflectivity model, the QCB on the Helstrom limit P_{H} [\hat{ρ}_{0,N}_{_{S}},\hat{ρ}_{I,κ}(σ_{κ}\sqrt{y_{κ}})] in Eq. (66) can be applied to obtain the upper bound:

$${P}_{C \to D} \leq {P}_{QCB , U} ≡ \frac{{inf}_{s ∈ [ 0 , 1 ]} Tr [ {\hat{ρ}}_{0 , {N}_{s}}^{s} {\hat{ρ}}_{I , κ}^{1 - s} ( {σ}_{κ} \sqrt{2 M} ) ]}{2} . \qquad ( 74 )$$

Here both \hat{ρ}_{0,N}_{_{S}} and \hat{ρ}_{I,κ} are diagonal in the number state basis and therefore can be efficiently evaluated.

Nair and Gu derived a lower bound on the error probability of quantum illumination (QI) target detection assisted by arbitrary form of entanglement. As this is the lower bound in the ideal case, it also holds as a lower bound in presence of additional noise. Considering M probes with mean photon number N_{S}, the following can be obtained:

$${P}_{C \to D} \geq {P}_{NG} = \frac{1}{4} {e}^{β {MN}_{s}} , \qquad ( 75 )$$

$$where β = - ln [ 1 - κ / ( {N}_{E} ( 1 - κ ) + 1 ) ] .$$

The upper bound P_{QCB,U} (double line) and lower bound P_{NG} (light gray solid) are plotted in FIG. 9A. Meanwhile, the QCB error exponent r_{QCB}≡lim_{M→∞}−ln P_{QCB,U}/M and \tilde{r}_{QCB}≡ln P_{QCB,U}/M are also plotted in FIGS. 9B and 9C. Indeed, QCB verifies the previous asymptotic evaluations.

### 3.4 Performance for Rayleigh-Fading Model

With the performance degradation from phase noise well understood, this portion of the disclosure considers Rayleigh-fading targets, where each target has a Rayleigh-distributed reflectivity besides a uniform random phase, i.e.,

$${P}_{κ} ( κ ) = {e}^{- κ / \overline{κ}} / \overline{κ} , \qquad ( 76 )$$

with k being the average reflectivity of the target. Note the above distribution is up to a cut-off so that κ∈[0,1].

As Eqs. (56) and (58) are now difficult to calculate numerically, to understand the QI performance for Rayleigh-fading targets, lower bounds and achievable performance (upper bounds) are considered.

### 3.4 a) Lower Bound

Applying concavity of the Helstrom limit to Eqs. (46) and (48):

$${P}_{C \to D} \geq {P}_{E , L B} ≡ \int {d}^{2 M} x d κ {P}_{K , X} ( κ , x ) {P}_{H} [ {\hat{ρ}}_{0 , {N}_{S}} , {\hat{ρ}}_{I , κ} ( x ) ] = \int d κ {dy}_{κ} \frac{1}{\overline{κ}} {e}^{- κ / \overline{κ}} {P}_{{χ}^{2}}^{( 2 M )} ( {y}_{k} ) {P}_{H} [ {\hat{ρ}}_{0 , {N}_{S}} , {\hat{ρ}}_{I , κ} ( {σ}_{κ} \sqrt{{y}_{κ}} ) ] \approx \int d κ \frac{1}{\overline{κ}} {e}^{- κ / \overline{κ}} {P}_{H} [ {\hat{ρ}}_{0 , {N}_{S}} , {\hat{ρ}}_{I , κ} ( \sqrt{2 M} {σ}_{κ} ) ] . \qquad ( 77 )$$

In the last step, the approximation is taken at the M>>1 limit, similar to Eq. (66). Now Eq. (77) can be evaluated via an approach similar to Eq. (62).

### 3.4 B) Achievable Performance

This section explores an achievable performance of the conversion unit 100 for the Rayleigh-fading model. Upon the heterodyne measurement results on the return x, direct photon counting can be performed on the idler output in state \hat{ρ}₁(x) from the conversion unit 100, followed by a threshold decision strategy at a fixed threshold independent of x. With the decision threshold optimized, the error probability can be expressed as:

$${P}_{C \to D} = {P}_{H} [ {\hat{ρ}}_{0 , {N}_{S}} , \int {d}^{2 M} x {P}_{x} ( x ) {\hat{ρ}}_{I} ( x ) ] = {P}_{H} [ {\hat{ρ}}_{0 , {N}_{S}} , \int d κ d {y}_{κ} \frac{1}{\overline{κ}} {e}^{- κ / \overline{κ}} P \frac{( 2 M )}{{χ}^{2}} ( {y}_{κ} ) \hat{{ρ}_{I , κ}} ( {σ}_{κ} \sqrt{{y}_{κ}} ) ] \approx {P}_{H} [ {\hat{ρ}}_{0 , {N}_{S}} , \int d κ \frac{1}{\overline{κ}} {e}^{- κ / \overline{κ}} {\hat{ρ}}_{I , κ} ( \sqrt{2 M} {σ}_{κ} ) ] , \qquad ( 78 )$$

where in the last step the measurement distribution is approximated as a delta-function at the large M limit.

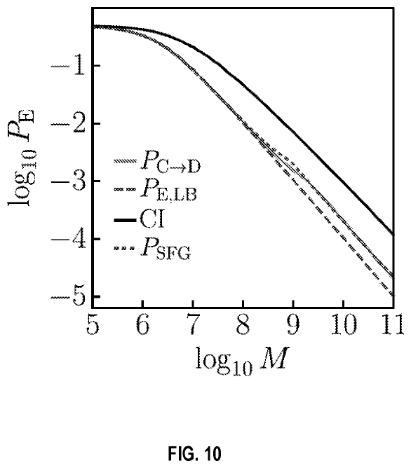

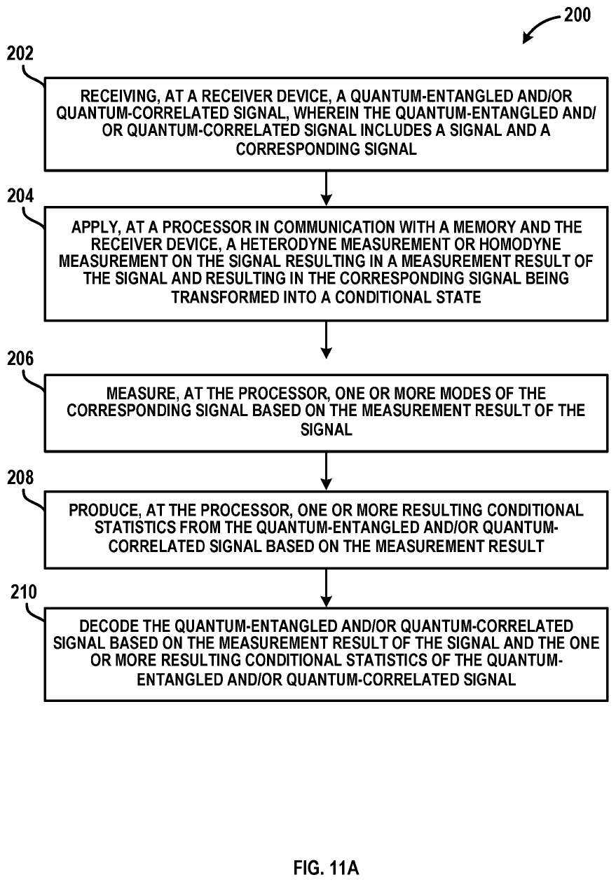

FIG. 10 plots the achievable performance P_{C→D} (gray solid), the lower bound P_{E,LB} (longer dashes) and the optimum CI's error probability (black solid) versus the number of modes. The quantum advantage over CI is shown to persist for the Rayleigh-fading model, although it is further reduced when compared with the random phase model. The plot also shows that the results agree with the QI detection for the Rayleigh-fading targets with the P_{SFG} reception P_{SFG} (shorter dashes), where the error probability decays with the number of modes in a polynomial fashion. Indeed, the achievable result P_{C→D} of the conversion unit agrees fairly well with P_{SFG}. While the SFG results require an approximate solution of a complex quantum nonlinear optical process, the achievable performance of the conversion unit 100 is almost exact, and requires little effort in calculations.

As such, the above analyses support the assertion that entanglement-assisted target detection performance of the conversion unit 100 is feasible in the more practical scenario of random phase noise and reflectivity fluctuation. The results show, in the scenario of only random phase noise, the conversion unit 100 still affords six-decibel error exponent advantage over the optimum classical illumination when the signal brightness is small. While in consideration of the Rayleigh reflection, the advantage is smaller, although being non-zero.

### 5. Methods

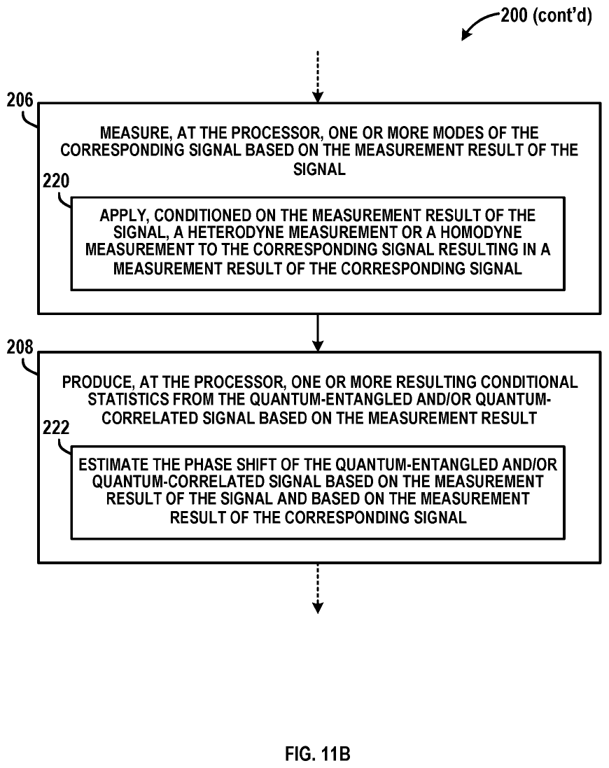

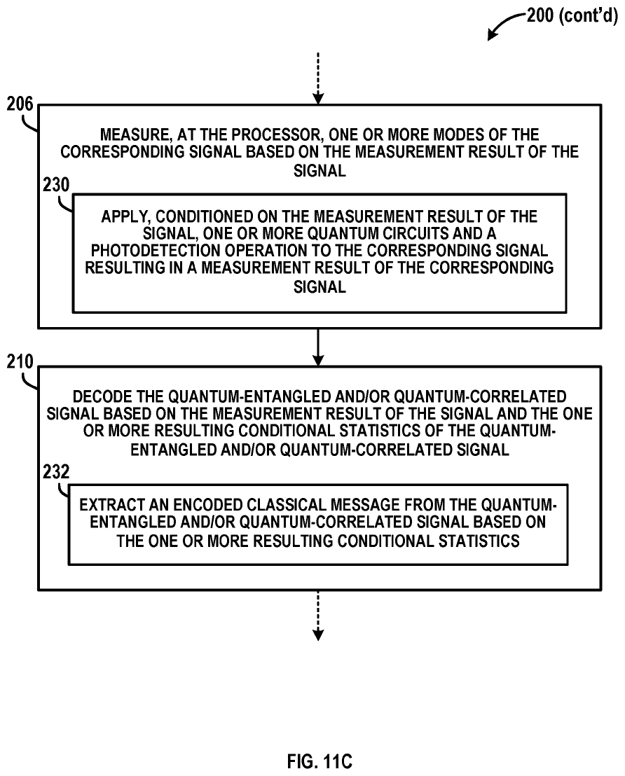

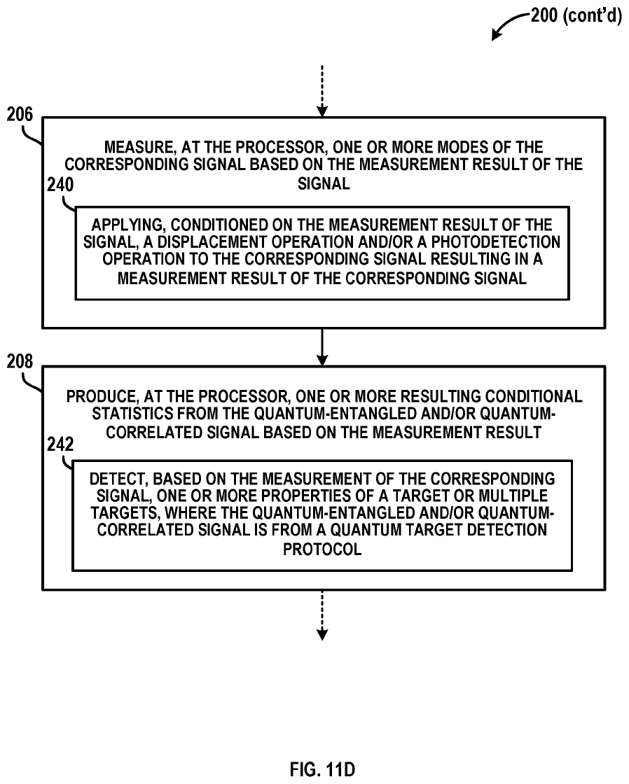

FIGS. 11A-11D show a method 200 for interpreting a quantum-entangled and/or quantum-correlated signal received at a receiver device (e.g., receiver device 20 shown in shown in FIGS. 1A-1C) by a conversion unit (e.g., conversion unit 100 shown in FIGS. 1B, 1C, and 7) outlined herein. In particular, FIG. 11A shows general steps of the method 200 from receipt of the quantum-entangled and/or quantum-correlated signal at the receiver device to decoding the quantum-entangled and/or quantum-correlated signal at the conversion unit. FIGS. 11B-11D show sub-steps of select general steps shown in FIG. 11A for different practical applications of the conversion unit. Further, the method can also include steps associated with providing the conversion unit 100, including instructions within a memory in communication with a processor of the conversion unit 100 executable by the processor to perform steps of the method 200 shown in FIGS. 11A-11D.

Referring to FIG. 11A, the method 200 starts at step 202, which includes receiving, at a receiver device, a quantum-entangled and/or quantum-correlated signal, wherein the quantum-entangled and/or quantum-correlated signal includes a signal and a corresponding signal. The signal received at the receiver device is a return signal and the corresponding signal received at the receiver device is an idler signal that corresponds directly with the return signal, and the idler signal is stored at the receiver device upon receipt. Step 204 of method 200 includes applying, at a processor in communication with a memory and the receiver device, a heterodyne measurement or homodyne measurement on the signal resulting in a measurement result of the signal and resulting in the corresponding signal being transformed into a conditional state.

Step 206 of method 200 includes measuring, at the processor, one or more modes of the corresponding signal based on the measurement result of the signal. Importantly, measurement of the one or more modes of the corresponding signal is dependent upon the practical application, and particularly dependent upon a frequency range of the quantum-entangled and/or quantum-correlated signal. Sub-steps of step 206 for phase sensing, entanglement-assisted communication, and quantum illumination are respectively shown in FIGS. 11B, 11C, and 11D.

Step 208 of method 200 includes producing, at the processor, one or more resulting conditional statistics from the quantum-entangled and/or quantum-correlated signal based on the measurement result. When applicable, step 210 of method 200 includes decoding the quantum-entangled and/or quantum-correlated signal based on the measurement result of the signal and the one or more resulting conditional statistics of the quantum-entangled and/or quantum-correlated signal.

With reference to FIG. 11B directed to phase sensing, step 206 includes a sub-step 220 which includes applying, conditioned on the measurement result of the signal, a heterodyne measurement or a homodyne measurement to the corresponding signal resulting in a measurement result of the corresponding signal. Step 208 includes a sub-step 222, which can include estimating the phase shift of the quantum-entangled and/or quantum-correlated signal based on the measurement result of the signal and based on the measurement result of the corresponding signal.

FIG. 11C shows steps directed to entanglement-assisted communication, step 206 includes a sub-step 230 which includes applying, conditioned on the measurement result of the signal, one or more quantum circuits and a photodetection operation to the corresponding signal resulting in a measurement result of the corresponding signal. The one or more quantum circuits can, for example, include a beamsplitter array. Step 210 includes a sub-step 232 which includes extracting an encoded classical message from the quantum-entangled and/or quantum-correlated signal based on the one or more resulting conditional statistics.

As shown in FIG. 11D directed to QI-based target detection, step 206 includes a sub-step 240 which includes applying, conditioned on the measurement result of the signal, a displacement operation and/or a photodetection operation to the corresponding signal resulting in a measurement result of the corresponding signal. Step 208 includes a sub-step 242, which includes detecting, based on the measurement of the corresponding signal, one or more properties of a target or multiple targets, where the quantum-entangled and/or quantum-correlated signal is from a quantum target detection protocol. These properties can include, but are not limited to, a presence and/or an absence of the target or multiple targets, a range of the target or multiple targets, a velocity of the target or multiple targets and/or an angle of the target or multiple targets.

### 6. Computer-Implemented System

FIG. 12 is a schematic block diagram of an example device 300 that may be used with one or more embodiments described herein, e.g., as a component of the conversion unit 100 shown in FIGS. 1B, 1C, and 7, and implementing aspects of method 200 shown in FIGS. 11A-11D.

Device 300 comprises one or more network interfaces 310 (e.g., wired, wireless, PLC, etc.), at least one processor 320, and a memory 340 interconnected by a system bus 350, as well as a power supply 360 (e.g., battery, plug-in, etc.).

Network interface(s) 310 include the mechanical, electrical, and signaling circuitry for communicating data over the communication links coupled to a communication network. Network interfaces 310 are configured to transmit and/or receive data using a variety of different communication protocols. As illustrated, the box representing network interfaces 310 is shown for simplicity, and it is appreciated that such interfaces may represent different types of network connections such as wireless and wired (physical) connections. Network interfaces 310 are shown separately from power supply 360, however it is appreciated that the interfaces that support PLC protocols may communicate through power supply 360 and/or may be an integral component coupled to power supply 360.

Memory 340 includes a plurality of storage locations that are addressable by processor 320 and network interfaces 310 for storing software programs and data structures associated with the embodiments described herein. In some embodiments, device 300 may have limited memory or no memory (e.g., no memory for storage other than for programs/processes operating on the device and associated caches).

Processor 320 comprises hardware elements or logic adapted to execute the software programs (e.g., instructions) and manipulate data structures 345. An operating system 342, portions of which are typically resident in memory 340 and executed by the processor, functionally organizes device 300 by, inter alia, invoking operations in support of software processes and/or services executing on the device. These software processes and/or services may include C to D conversion unit processes/services 390 that implement aspects of the conversion unit 100 and the method 200. Note that while C to D conversion unit processes/services 390 is illustrated in centralized memory 340, alternative embodiments provide for the process to be operated within the network interfaces 310, such as a component of a MAC layer, and/or as part of a distributed computing network environment. Non-transitory computer-readable storage media refer to any medium or media that participate in providing instructions to a central processing unit (CPU) for execution, including instructions for executing aspects of method 200. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the C to D conversion unit processes/services 390 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, comprising:
a receiver device operable for receiving a quantum-entangled and/or quantum-correlated signal, wherein the quantum-entangled and/or quantum-correlated signal includes a signal and a corresponding signal; and
a processor in communication with a memory and the receiver device, the memory including instructions executable by the processor to:
apply a heterodyne measurement or homodyne measurement on the signal resulting in a measurement result of the signal and the corresponding signal being transformed into a conditional state;
measure one or more modes of the corresponding signal based on the measurement result of the signal; and
produce one or more resulting conditional statistics from the quantum-entangled and/or quantum-correlated signal based on the measurement result.

2. The system of claim 1, the memory further including instructions executable by the processor to:
decode the quantum-entangled and/or quantum-correlated signal based on the measurement result of the signal and the one or more resulting conditional statistics of the quantum-entangled and/or quantum-correlated signal.

3. The system of claim 1, the memory further including instructions executable by the processor to:
estimate a phase shift of the quantum-entangled and/or quantum-correlated signal.

4. The system of claim 3, the memory further including instructions executable by the processor to:
apply, conditioned on the measurement result of the signal, a heterodyne measurement or a homodyne measurement to the corresponding signal resulting in a measurement result of the corresponding signal; and
determine the phase shift of the quantum-entangled and/or quantum-correlated signal based on the measurement result of the signal and based on the measurement result of the corresponding signal.

5. The system of claim 1, where measurement of the one or more modes of the corresponding signal is dependent upon a frequency range of the quantum-entangled and/or quantum-correlated signal.

6. The system of claim 1, the memory further including instructions executable by the processor to:
apply, conditioned on the measurement result of the signal, a displacement operation and/or a photodetection operation on the corresponding signal resulting in a measurement result of the corresponding signal.

7. The system of claim 6, the memory further including instructions executable by the processor to:
detect, based on the measurement result of the corresponding signal, one or more properties of a target or multiple targets, including presence and/or absence of the target or multiple targets, range of the target or multiple targets, velocity of the target or multiple targets and/or angle of the target or multiple targets, wherein the quantum-entangled and/or quantum-correlated signal is from a quantum target detection protocol.

8. The system of claim 7, the memory further including instructions executable by the processor to:
iteratively apply the displacement operation and/or the photodetection operation on one or more components of the corresponding signal using at least one of: a classical control operation, a feed-forward operation and/or a feed-backward operation.

9. The system of claim 1, the memory further including instructions executable by the processor to:
apply, conditioned on the measurement result of the signal, one or more quantum circuits and a photodetection operation to the corresponding signal resulting in a measurement result of the corresponding signal.

10. The system of claim 9, the memory further including instructions executable by the processor to:
extract an encoded classical message from the quantum-entangled and/or quantum-correlated signal based on the one or more resulting conditional statistics.

11. The system of claim 9, wherein the one or more quantum circuits includes a beamsplitter array.

12. The system of claim 1, wherein the signal received at the receiver device is a return signal and the corresponding signal received at the receiver device is an idler signal that corresponds directly with the return signal, wherein the idler signal is stored at the receiver device upon receipt.

13. The system of claim 1, further comprising:
a transmitter device, wherein the transmitter device is operable for communication with the receiver device and wherein the transmitter device is operable for transmitting the quantum-entangled and/or quantum-correlated signal, wherein the quantum-entangled and/or quantum-correlated signal includes a primary signal and an idler signal that corresponds with the primary signal;
wherein the primary signal transmitted by the transmitter device corresponds to a return signal received at the receiver device, and wherein the return signal includes noise in addition to the primary signal.

14. A method, comprising:
providing a receiver device operable for receiving a quantum-entangled and/or quantum-correlated signal, wherein the quantum-entangled and/or quantum-correlated signal includes a signal and a corresponding signal; and
providing a processor in communication with a memory and the receiver device, the memory including instructions executable by the processor to:
apply a heterodyne measurement or homodyne measurement on the signal resulting in a measurement result of the signal and the corresponding signal being transformed into a conditional state;
measure one or more modes of the corresponding signal based on the measurement result of the signal; and
produce one or more resulting conditional statistics from the quantum-entangled and/or quantum-correlated signal based on the measurement result.

15. The method of claim 14, further comprising:
providing instructions within the memory executable by the processor to:
decode the quantum-entangled and/or quantum-correlated signal based on the measurement result of the signal and the one or more resulting conditional statistics of the quantum-entangled and/or quantum-correlated signal.

16. The method of claim 14, further comprising:
providing instructions within the memory executable by the processor to:
apply, conditioned on the measurement result of the signal, a heterodyne measurement or a homodyne measurement to the corresponding signal resulting in a measurement result of the corresponding signal; and
estimate a phase shift of the quantum-entangled and/or quantum-correlated signal based on the measurement result of the signal and based on the measurement result of the corresponding signal.

17. The method of claim 14, further comprising:
providing instructions within the memory executable by the processor to:
apply, conditioned on the measurement result of the signal, a displacement operation and/or a photodetection operation on the corresponding signal resulting in a measurement result of the corresponding signal; and
detect, based on the measurement result of the corresponding signal, one or more properties of a target or multiple targets, including presence and/or absence of the target or multiple targets, range of the target or multiple targets, velocity of the target or multiple targets and/or angle of the target or multiple targets, wherein the quantum-entangled and/or quantum-correlated signal is from a quantum target detection protocol.

18. The method of claim 14, further comprising:
providing instructions within the memory executable by the processor to:
apply, conditioned on the measurement result of the signal, one or more quantum circuits and a photodetection operation to the corresponding signal resulting in a measurement result of the corresponding signal; and
extract an encoded classical message from the quantum-entangled and/or quantum-correlated signal based on the one or more resulting conditional statistics.

19. A non-transitory computer-readable storage medium having instructions embodied thereon, the instructions executable by a computing system to perform a method for interpreting a quantum-entangled and/or quantum-correlated signal, the method comprising:
applying a heterodyne measurement or homodyne measurement on a signal of a quantum-entangled and/or quantum-correlated signal, resulting in a measurement result of the signal and resulting in a corresponding signal of the quantum-entangled and/or quantum-correlated signal being transformed into a conditional state;
measuring one or more modes of the corresponding signal based on the measurement result of the signal; and
producing one or more resulting conditional statistics from the quantum-entangled and/or quantum-correlated signal based on the measurement result.

20. The non-transitory computer-readable storage medium of claim 19, having instructions embodied thereon and executable by the computing system to perform the method further comprising:
receiving, from a receiver device in communication with the computing system, data indicative of the quantum-entangled and/or quantum-correlated signal, wherein the quantum-entangled and/or quantum-correlated signal includes the signal and the corresponding signal;
wherein the signal received at the receiver device is a return signal and the corresponding signal received at the receiver device is an idler signal that corresponds directly with the return signal, wherein the idler signal is stored at the receiver device upon receipt.
